(19) United States
(12) Patent Application Publication
(10) Pub. No.: US 2008/0279132 A1
(43) Pub. Date: Nov. 13, 2008

(54) Wireless Communication Device

(75) Inventors: Yujin Noishiki, Fujimino-shi (JP); Misato Sasaki, Fujimino-shi (JP); Akira Idoue, Fujimino-shi (JP)

Correspondence Address: MORGAN LEWIS & BOCKIUS LLP, 1111 PENNSYLVANIA AVENUE NW, WASHINGTON, DC, 20004, US

(73) Assignee: KDDI R&D Laboratories Inc., Fujimino-shi (JP)

(21) Appl. No.: 12/116,507

(22) Filed: May 7, 2008

(30) Foreign Application Priority Data
May 11, 2007 (JP) 2007-126641

(51) Int. Cl. H04H 20/71

(52) U.S. Cl. 370/312

(57) ABSTRACT

A plurality of nodes each including a transmitter, a receiver, and a controller is linked together via a network. The transmitter of a transmission node using multiple wireless interfaces sends a beacon message sending its own node identifier and wireless interfaces to at least one reception node, which in turn sends back a response message sending its own node identifier and at least one usable wireless interface. The controller of the transmission node determines the broadcast order based on the response message received by the receiver. The transmitter of the transmission node performs broadcasting or multicasting using the wireless interface, which is selected based on the broadcast order. Thus, it is possible to perform broadcasting or multicasting at an efficient usage of radio frequency while covering all reachable neighboring nodes in node-to-node wireless communications based on multiple wireless communication methods.

### BACKGROUND OF THE INVENTION

1. Field of the Invention

The present invention relates to wireless communication devices allowing communications to be performed based on multiple wireless communication methods.

The present application claims priority on Japanese Patent Application No. 2007-126641, the content of which is incorporated herein by reference.

2. Description of the Related Art

Link aggregation (based on IEEE 802.3ad) is the known technology for bundling multiple interfaces, in which multiple physical links are regarded as a single virtual link. For example, eight links each enabling communication with 1 Gbps bandwidth are bundled together to form a virtual link enabling communication with 8 Gbps bandwidth. Link aggregation is advantageous in that it can broaden bandwidths without using high-speed lines. In addition, it has a relatively high resistance against problems because it allows lines to continue communications by use of other links even when problems occur in physical links. Various documents such as Patent Document 1 and Non-Patent Document 1 teach link aggregation in connection with Internet Group Management Protocols.
Patent Document 1: Japanese Unexamined Patent Application Publication No. 2006-5437.
Non-Patent Document 1:1 GMPv3: B. Cain, S. Deering, I. Kouvelas, B. Fenner and A. Thyagarajan, “Internet Group Management Protocol, Version 3.” IETF RCF 3376, 2002
Patent Document 1 teaches a traffic distributed control device that equalizes output flows with respect to physical ports including multicast ports.

It is necessary that counterpart devices have ports satisfying five conditions (1) to (5) when bundling ports by way of link aggregation.
(1) They are applied to IEEE 802.3 CSMA/CD LAN (i.e. Carrier Sense Multiple Access/Collision Detection Local Area Network, which is the communication method used by the Ethernet, a registered trademark).
(2) They support link aggregation.
(3) The same line speed is applied to bundled ports.
(4) They use full duplex communication allowing transmission and reception to be simultaneously performed.
(5) Counterpart devices are connected together via point-to-point connections.

The five conditions will be further examined as follows:
(1) LAN standards define various communication speeds of ports subjected to link aggregation as 10 Mbps, 100 Mbps, and 1 Gbps as well as 10 Gbps (e.g. 10 Gigabit Ethernet, a registered trademark) standardized by IEEE 802.3ae. Standardization has been implemented with respect to 10 Gbps; hence, various venders developed new routers and switches having 10 Gbps interfaces. All the 10 Gbps interfaces may not always be applied to link aggregation due to different technical specifications thereof.
(2) Link aggregation should be applied to counterpart devices communicating with each other via bundled lines therebetween.
(3) It is impossible to bundle ports having different speeds such as 10 Mbps and 100 Mbps; hence, it is necessary to bundle ports having the same speed, such as ports of 10 Mbps and ports of 100 Mbps.
(4) Link aggregation does not support semi-duplex communication methods because it supports full duplex communication methods only.
(5) Counterpart devices should be normally connected via point-to-point connections; in other words, link aggregation is not applicable to point-to-multipoint connections for connecting multiple devices. Therefore, link aggregation defined by IEEE 802.3ad cannot be applied to wireless interfaces suiting multiple wireless communication methods since they are connected together via point-to-multipoint connections.

IGMP (Internet Group Management Protocol) teaches the technology for managing multicast transmission destinations. This technology is disclosed in Non-Patent Document 1, for example. In the IGMP, routers perform management as to whether or not hosts joining multicast groups exist on subnets. It is used to communicate management information regarding multicast groups between neighboring multicast routers. Multicast routers periodically multicast IGMP references to 224.0.0.1 via TTL=1. Herein, only one of hosts receiving them is required to respond to IGMP references because multicast routers do not request to inform the number of hosts but the existence of hosts instead.

The IGMP applied to wireless communication using multiple wireless interfaces such as cognitive radio communication suffers from the following drawbacks.

When wireless communication is performed between two nodes each applicable to multiple wireless communication methods, links may be established between two nodes in accordance with multiple wireless communication methods. The IGMP does not recognize how many transmission sources and destinations exist in multicast groups in connection with interfaces. For this reason, multicast data may be transmitted from one transmission source to one transmission destination via multiple wireless interfaces in a duplex manner.

Wireless link configurations may differ with respect to nodes having different wireless communication methods or with respect to nodes having different propagation distances relative to wireless communication methods. When broadcasting and multicasting are performed using wireless interfaces via the aforementioned network configurations, frequency efficiencies may be degraded due to unexpected duplication of packets between wireless interfaces. When broadcasting and multicasting are performed using a part of wireless interfaces, packets may not always reach within target areas. For example, packets subjected to broadcasting and multicasting may not reach a part of nodes existing on the network.

### SUMMARY OF THE INVENTION

It is an object of the present invention to provide a wireless communication device the can cover all reachable areas while performing broadcasting and multicasting with efficient usage of radio frequency in wireless communication performed between nodes each applicable to multiple wireless communication methods.

In a first aspect of the present invention, a wireless communication device includes a transmitter suiting a plurality of wireless communication methods, a receiver suiting the plurality of wireless communication methods, and a controller for determining a broadcast order with regard to the wireless communication methods. The transmitter broadcasts a beacon message to a counterpart wireless communication device, which in turn sends back a response message indicating a node identifier and at least one usable wireless communication method to the receiver. The controller determines the broadcast order based on the response message. The transmitter performs broadcasting or multicasting based on one of the wireless communication methods, which is determined based on the broadcast order.

In the above, the wireless communication device further includes a storage for storing the node identifier and the sequence number thereof, wherein the transmitter sends the beacon message sending the node identifier and the sequence number to the counterpart wireless communication device based on the wireless communication methods sequentially.

In addition, the controller selects at least one of the wireless communication methods via which the receiver receives the response message, wherein the transmitter performs broadcasting or multicasting based on the selected wireless communication method.

Furthermore, the controller selects at least one of the wireless communication methods reaching a prescribed number of neighboring nodes, so that the transmitter performs broadcasting or multicasting based on the selected wireless communication method.

Moreover, the receiver receives the response message from the counterpart wireless communication device, so that the transmitter performs broadcasting or multicasting based on the at least one usable wireless communication method.

In a second aspect of the present invention, a wireless communication device includes a transmitter suiting at least one wireless communication method, a receiver suiting the at least one wireless communication method, and a controller for determining a broadcast order with regard to the at least one wireless communication method. Herein, the receiver receives a beacon message from a counterpart wireless communication device. The transmitter sends a response message sending a node identifier and the at least one wireless communication method to the counterpart wireless communication device.

In the above, the wireless communication device further includes a storage for storing the node identifier and the sequence number thereof, wherein the controller determines whether or not the storage stores the node identifier and the sequence number described in the beacon message received by the receiver. When the controller determines that the storage does not store the node identifier and the sequence number indicated in the beacon message, the storage is controlled to store the node identifier and the sequence number described in the beacon message, so that the transmitter sends back the response message to the counterpart wireless communication device.

As described above, the wireless communication device of the present invention performs broadcasting or multicasting at efficient usage of radio frequency while covering all reachable regions in wireless communications between nodes each applicable to multiple wireless communication methods.

### BRIEF DESCRIPTION OF THE DRAWINGS

These and other objects, aspects, and embodiments of the present invention will be described in more detail with reference to the following drawings, in which:

FIG. 1 is a block diagram showing the constitution of a wireless communication device in accordance with a preferred embodiment of the present invention;

FIG. 2 shows a network system including a plurality of nodes performing communications therebetween via wireless interfaces;

FIG. 3 shows a neighboring node wireless interface configuration table;

FIG. 4 shows a private node wireless interface configuration table;

FIG. 5 is a flowchart showing a wireless interface configuration acknowledgement process at a transmission node;

FIG. 6 shows an example of a format of a beacon message;

FIG. 7 is a flowchart showing a wireless interface configuration acknowledgement process at a reception node;

FIG. 8 shows an example of a format of a beacon management table;

FIG. 9 shows an example of a format of a response message;

FIG. 10 is a flowchart showing a broadcast order termination process regarding wireless interfaces;

FIG. 11 shows a network system including a plurality of nodes performing communications therebetween via wireless interfaces in accordance with a first operation;

FIG. 12 shows a neighboring node wireless interface configuration table stored in a node Z shown in FIG. 11 in accordance with the first operation;

FIG. 13 shows a private node wireless interface configuration table stored in the node Z in accordance with the first operation;

FIG. 14 shows the content of the neighboring node wireless interface configuration table, which is stored in the node Z after completion of broadcast and unicast communications with nodes A and B in accordance with the first operation;

FIG. 15 shows the content of the private node wireless interface configuration table, which is stored in the node Z after completion of broadcast and unicast communications with the nodes A and B in accordance with the first operation;

FIG. 16 shows the content of the neighboring node wireless interface configuration table, which is stored in the node Z after completion of broadcast and unicast communications with the nodes A and C in accordance with the first operation;

FIG. 17 shows the content of the private node wireless interface configuration table, which is stored in the node Z after completion of broadcast and unicast communications with the nodes A and C in accordance with the first operation;

FIG. 18 shows the content of the neighboring node wireless interface configuration table, which is stored in the node Z after completion of the broadcast order determination process in accordance with the first operation;

FIG. 19 shows the content of the private node wireless interface configuration table, which is stored in the node Z after completion of the broadcast order determination process in accordance with the first operation;

FIG. 20 shows the network system including four nodes such as nodes Z, A, B, and C, which perform communications therebetween via wireless interfaces in accordance with a second operation;

FIG. 21 shows a neighboring node wireless interface configuration table, which is initially stored in the node Z in accordance with the second operation;

FIG. 22 shows a private node wireless interface configuration table, which is initially stored in the node Z in accordance with the second operation;

FIG. 23 shows the content of the neighboring node wireless interface configuration table, which is stored in the node Z after completion of broadcast and unicast communications with the node A in accordance with the second operation;

FIG. 24 shows the content of the private node wireless interface configuration table, which is stored in the node Z after completion of broadcast and unicast communications with the node A in accordance with the second operation;

FIG. 25 shows the content of the neighboring node wireless interface configuration table, which is stored in the node Z after completion of broadcast and unicast communications with the nodes B and C in accordance with the second operation;

FIG. 26 shows the content of the private node wireless interface configuration table, which is stored in the node Z after completion of broadcast and unicast communications with the nodes B and C in accordance with the second operation;

FIG. 27 shows the content of the neighboring node wireless interface configuration table, which is stored in the node Z after completion of broadcast and unicast communications with the nodes A, B and C in accordance with the second operation;

FIG. 28 shows the content of the private node wireless interface configuration table, which is stored in the node Z after completion of broadcast and unicast communications with the nodes A, B and C in accordance with the second operation;

FIG. 29 shows the content of the neighboring node wireless interface configuration table, which is stored in the node Z after completion of the broadcast order determination process in accordance with the second operation; and

FIG. 30 shows the content of the private node wireless interface configuration table, which is stored in the node Z after completion of the broadcast order determination process in accordance with the second operation.

### DESCRIPTION OF THE PREFERRED EMBODIMENT

The present invention will be described in further detail by way of examples with reference to the accompanying drawings.

### 1. Wireless Communication Device

FIG. 1 is a block diagram showing the constitution of a wireless communication device (serving as a node) in accordance with a preferred embodiment of the present invention. A transmitter 101 transmits data to a counterpart wireless communication device (or a counterpart node). The transmitter 101 has a plurality of wireless communication interfaces for use in transmission. A receiver 102 receives data transmitted from the counterpart wireless communication device. The receiver 102 has a plurality of wireless communication interfaces for use in reception. The transmitter 101 and the receiver 102 are capable of performing mutual communication via wireless communication interfaces based on the same wireless communication method such as IEEE 802.11a and IEEE 802.15.1. A controller 103 determines the wireless communication method for use in transmission of data to the counterpart wireless communication device. The controller 103 determines whether to send a response message to the counterpart communication device. A storage 104 stores information regarding the wireless communication method(s) used in the counterpart wireless communication device. The storage 104 stores the status regarding connection with the counterpart communication device.

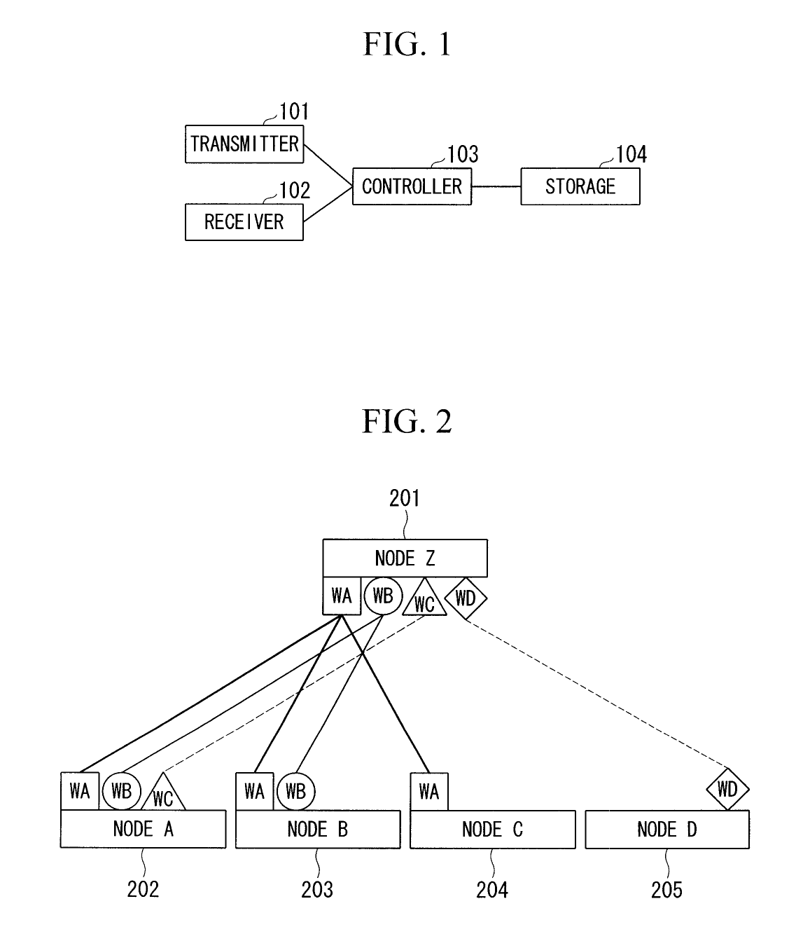

FIG. 2 shows an example of network system including nodes 201 to 205. The node 201 (referred to as a node Z) serves as a multicast transmission source node. The nodes 202, 203, 204, and 205 (referred to as nodes A, B, C, and D) serve as multicast reception nodes. The node 201 has a plurality of wireless communication interfaces suited to four types of wireless communication methods, namely, WA, WB, WC, and WD. The node 202 has a plurality of wireless communication interfaces suited to the three types of wireless communication methods, namely, WA, WB, and WC. The node 203 has a plurality of wireless communication interfaces suited to two types of wireless communication methods, namely, WA and WB. The node 204 has a wireless communication interface suited to one wireless communication method, namely, WA. The node 205 has a wireless communication interface suited to one wireless communication method, namely, WD.

The nodes 201 to 205 are directly designated by different node identifiers. Specifically, the node 201 has a node identifier Z; the node 202 has a node identifier A; the node 203 has a node identifier B; the node 204 has a node identifier C; and the node 205 has a node identifier D. As each of the node identifiers, it is possible to use a MAC (Media-Access Control) address regarding wireless interfaces or to use a global IP address.

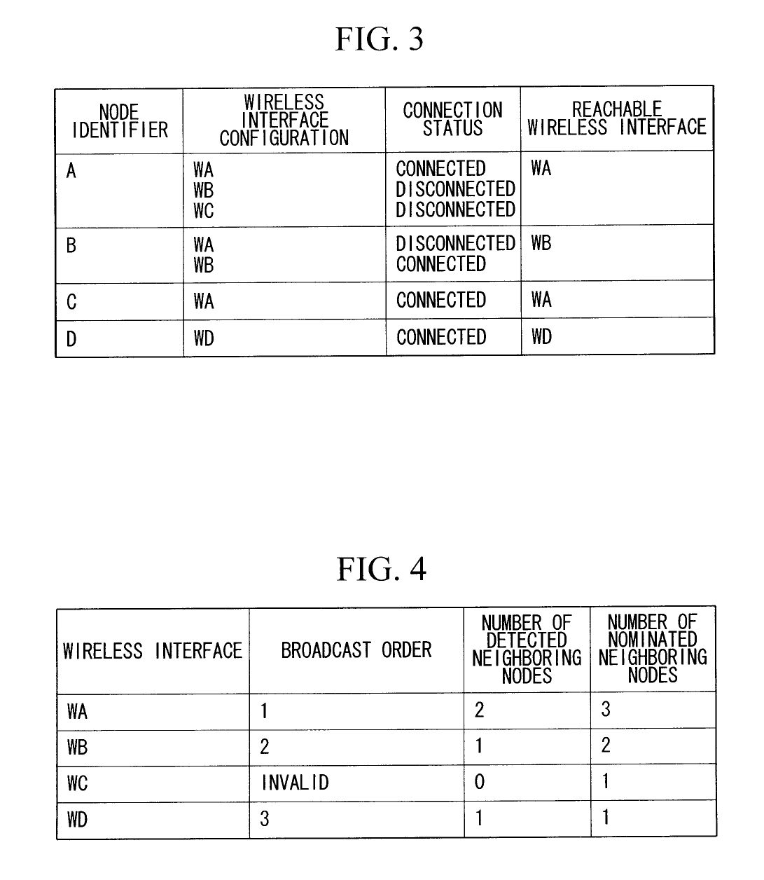

FIG. 3 shows a neighboring node wireless interface configuration table stored in the node 201. The neighboring node wireless interface configuration table defines various attributes such as node identifiers, wireless interface configurations, connection statuses, and reachable wireless interfaces. The wireless interface configuration shows wireless interfaces assigned to nodes each designated by its own node identifier. The connection status shows whether or not each node is connected to or disconnected from each wireless interface based on its wireless communication method. When “connected”, each node receives a response message from each wireless interface based on its wireless communication method. The details of the response message will be described later. The reachable wireless interface shows each reachable wireless interface that can reliably transmit data to each node designated by its node identifier.

The neighboring node wireless interface configuration table of FIG. 3 defines four regions, each of which stores information regarding each node. In the first region regarding the node 202 designated by the node identifier A, the wireless interface configuration lists the wireless interfaces WA, WB, and WC; the connection status is “connected” for WA and “disconnected” for WB and WC; the reachable wireless interface designates the wireless interface WA. In the second region regarding the node 203 designated by the node identifier B, the wireless interface configuration lists the wireless interfaces WA and WB; the connection status is “disconnected” for WA and “connected” for WB; and the reachable wireless interface designates the wireless interface WB. In the third region regarding the node 204 designated by the node identifier C, the wireless interface configuration lists the wireless interface WA; the connection status is “connected” for WA; and the reachable wireless interface designates the wireless interface WA. In the fourth region regarding the node 205 designated by the node D, the wireless interface configuration lists the wireless interface WD; the connection status is “connected” for WD; and the reachable wireless interface designates the wireless interface WD.

FIG. 4 shows a private node wireless interface configuration table, stored in the node 201 (designated by the node identifier Z), which defines various attributes such as wireless interfaces, broadcast orders, numbers of detected neighboring nodes, and numbers of nominated neighboring nodes. The broadcast order shows the order of wireless interfaces, each of which can be used by the node 201 performing broadcasting. The private node wireless interface configuration table of FIG. 4 shows that broadcasting is performed using the wireless interface WA first, the wireless interface WB second, and the wireless interface WD third. The broadcast order is “invalid” with respect to the wireless interface WC, which is not used for broadcasting. The number of detected neighboring nodes shows the number of wireless communication devices (or nodes), which send back responses to beacons corresponding to broadcast messages transmitted by wireless interfaces with respect to respective regions. The number of nominated neighboring nodes shows the number of wireless communication devices having wireless interfaces with respect to respective regions.

The private node wireless interface configuration table of FIG. 4 defines four regions, each of which stores information regarding each wireless interface. In the first region regarding the wireless interface WA, the broadcast order is “1”; the number of detected neighboring nodes is “2”; and the number of nominated neighboring nodes is “3”. In the second region regarding the wireless interface WB, the broadcast order is “2”; the number of detected neighboring nodes is “1”; and the number of nominated neighboring nodes is “2”. In the third region regarding the wireless interface WC, the broadcast order is “invalid”; the number of detected neighboring nodes is “0”; and the number of nominated neighboring nodes is “1”. In the fourth region regarding the wireless interface WD, the broadcast order describes “3”; the number of detected neighboring nodes is “1”; and the number of nominated neighboring nodes is “1”.

### 2. Wireless Interface Configuration Acknowledgement Process

(A) Wireless Interface Configuration Acknowledgement Process at Transmission Node (or Source Node)

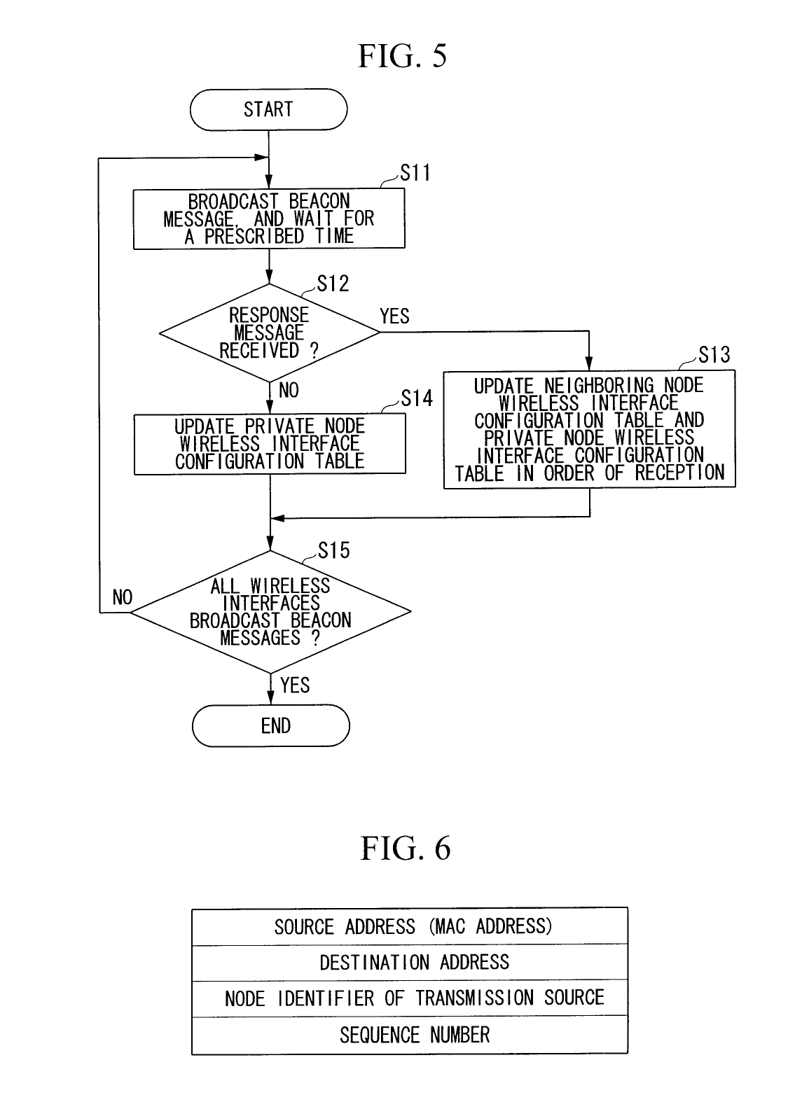

The wireless interface configuration acknowledgement process at a transmission node (or a source node) will be described with reference to FIG. 5. FIG. 5 is a flowchart showing the wireless interface configuration acknowledgement process at the transmission node. In the transmission node, the transmitter 101 periodically broadcasts beacons to a reception node, wherein after one broadcasting, it stops transmitting for a prescribed time in step S11. Broadcasting is performed using a wireless interface having the highest place of order within wireless interfaces not transmitting beacons. FIG. 6 shows an example of a format of a beacon message, which includes a source address, a destination address, a source node identifier, and a sequence number. The source address indicates an address of the transmission node for transmitting a beacon message, wherein it uses a MAC address, for example. The destination address indicates a broadcast address representing a broadcast destination. The sequence number indicates a prescribed number (which is assigned to a series of procedures), which is increased by one upon completion of a series of procedures. The beacon transmission timing is determined in correspondence with beacon transmission time intervals defined by wireless communication methods. In IEEE 802.11, each beacon message is transmitted with a 3-second time interval. The wait time after broadcasting is determined in advance. Just after start-up when the broadcast order is not determined yet, it can be determined in a random manner.

Subsequent to step S11, the flow proceeds to step S12 in which a decision is made as to whether or not the receiver 102 receives a response message within the prescribed wait time. When the controller 103 detects that the receiver 102 of the transmission node receives the response message, the flow proceeds to step S13 in which the neighboring node wireless interface configuration table and the private node wireless interface configuration table stored in the storage 104 are updated based on the response message in the order of reception; then, the flow proceeds to step S15. When a new node identifier is registered with the neighboring node wireless interface configuration table, the reachable wireless interface is “invalid” in the corresponding region. Details will be described later, wherein the response message includes a node identifier and a wireless interface regarding a reception node (or a response node) as well as the source address, destination address, node identifier, and sequence number regarding the transmission node.

Suppose that the transmitter 101 of the transmission node sends a beacon message via the wireless interface WA; then, the receiver 102 receives a response message including the node identifier A and the wireless interfaces WA and WB with regard to the response node. In this case, the controller 103 of the transmission node newly adds the node identifier A to the neighboring node wireless interface configuration table stored in the storage 104, in which the wireless interface configuration lists WA and WB, the connection status is “connected” for WA and “disconnected” for WB, and the reachable wireless interface is “invalid” in the corresponding region. In addition, the controller 103 adds “1” to the number of detected neighboring nodes and the number of nominated neighboring nodes in the private node wireless interface configuration table stored in the storage 104 in the region regarding the wireless interface WA. Furthermore, the controller 103 adds “1” to the number of nominated neighboring nodes in the region regarding the wireless interface WB. When the controller 103 does not detect the response message in step S12, the flow proceeds to step S14 in which the controller 103 sets the number of detected neighboring nodes to “0” in the private node wireless interface configuration table in the region regarding the wireless interface used for transmitting the beacon message; then, the flow proceeds to step S15.

In step S15, a decision is made as to whether or not the beacon message is completely transmitted using all the wireless interfaces. When at least one wireless interface does not transmit the beacon message, the flow returns to step S11. When all the wireless interfaces transmit the beacon message, the wireless interface configuration acknowledgement process of FIG. 5 is ended; then, the controller 103 waits for the next cycle of execution.

(B) Wireless Interface Configuration Acknowledgement Process at Reception Node (or Destination Node)

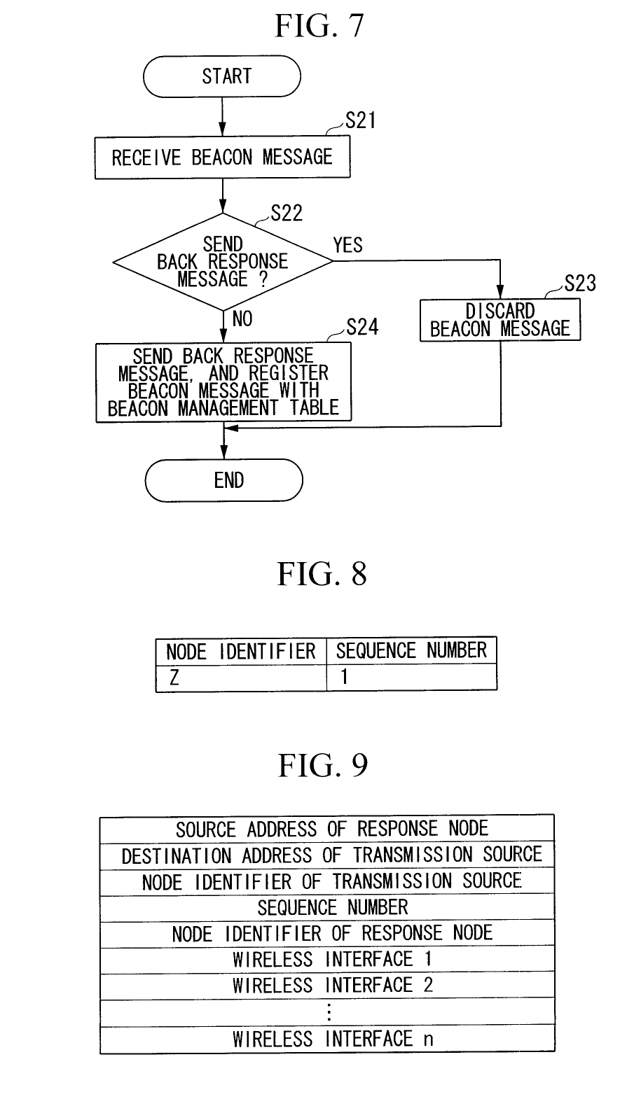

Wireless interface configuration acknowledgement process at a reception node will be described with reference to FIG. 7. FIG. 7 is a flowchart showing the wireless interface configuration acknowledgement process at the reception node. In step S21, the receiver 102 of the reception node receives the beacon message broadcast from the transmission node. In step S22, a decision is made as to whether or not the controller 103 sends back a response message to the transmission node with reference to the node identifier and the sequence number included in the beacon message and with reference to a beacon management table stored in the storage 104. FIG. 8 shows an example of a format of the beacon management table, which defines two attributes, i.e., the node identifier and the sequence number. One region describes the sequence number with respect to one node identifier. FIG. 8 shows only one region in which the sequence number is “1” with respect to the node identifier Z. When the combination of the node identifier and sequence number included in the beacon message (received by the receiver 102) matches the combination of the node identifier and sequence number (described in the beacon management table stored in the storage 104), the controller 103 determines that the reception node has already sent back the response message to the transmission node. When the controller 103 determines in step S22 that the reception node has already sent back the response message to the transmission node, the receiver 102 discards the received beacon message in step S23; then, the wireless interface configuration acknowledgement table of FIG. 7 is ended.

When the controller 103 determines in step S22 that the reception node does not send back the response message to the transmission node, the flow proceeds to step S24 in which the transmitter 101 of the reception node sends back the response message via unicast communication; then, the node identifier and sequence number included in the beacon message are registered with the beacon management table stored in the storage 104. FIG. 9 shows an example of a format of the response message, which includes the source address, the destination address, the node identifier of the transmission source, the sequence number, the node identifier of the reception node (or response node), and the wireless interfaces. The source address indicates the address of the reception node (or response node) for sending back the response message to the transmission node. The destination address indicates the address of the transmission node for transmitting the beacon message. The node identifier of the transmission source indicates the node identifier of the transmission node for transmitting the beacon message. The sequence number is identical to the sequence number included in the beacon message received by the receiver 102. The node identifier of the reception node indicates the node identifier of the response node for sending back the response message. The wireless interfaces indicate the wireless interfaces that are incorporated into the transmitter 101 of the reception node and are used to send back the response message to the transmission node. In order to prevent multiple neighboring nodes from sending back response messages at the same timing, the controller 103 of each node calculates a random time so that the transmitter 101 sends back the response message after a lapse of the calculated time.

By way of the aforementioned processes, the transmission node updates the neighboring node wireless interface configuration table describing the node identifier, wireless interface configuration, connection status, and reachable wireless interface in the storage 104 in accordance with the message received by the receiver 102. In addition, it updated the private node wireless interface configuration table describing the number of detected neighboring nodes and the number of nominated neighboring nodes in the storage 104 in accordance with the message received by the receiver 102. It may be stated that, in certain region of the private node wireless interface configuration table in which number of detected neighboring nodes differs from the number of nominated neighboring nodes, the number of reachable wireless interfaces may be greater than the number of detected neighboring nodes. This may occur due to the broadcast order by which the beacon message is transmitted using multiple wireless interfaces. Herein, the sequence number is renewed with regard to the region in which the number of detected neighboring nodes differs from the number of nominated neighboring nodes; then, the wireless interface configuration acknowledgement process is performed again so as to reacquire the node identifier, wireless interface configuration, and connection status with respect to each neighboring node. However, there is a different event in which each neighboring node having wireless interfaces is located out of the communication area so that the number of detected neighboring nodes differs from the number of nominated neighboring nodes. Such an event may disappear by way of the next cycle of execution of the wireless interface configuration acknowledgement process. Hence, it is not always necessary to renew the sequence number with regard to the region in which the number of detected neighboring nodes differs from the number of nominated neighboring nodes and to perform the wireless interface configuration acknowledgement process again.

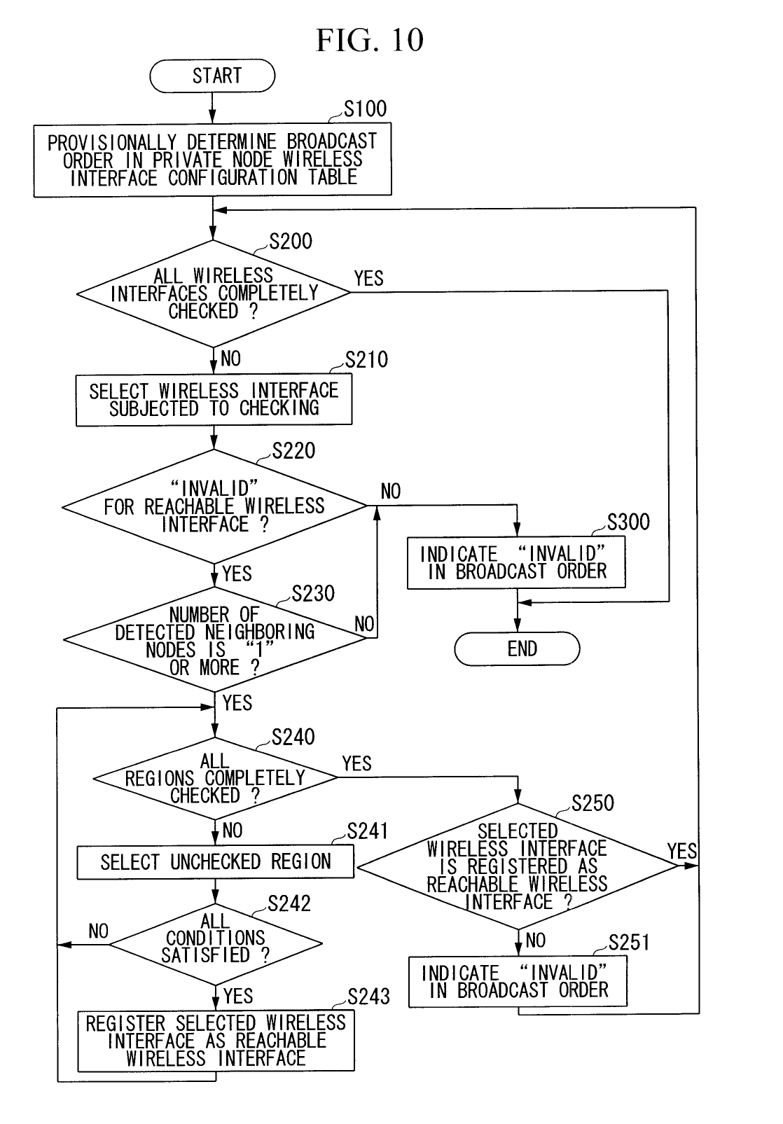

Next, a broadcast order determination process regarding wireless interfaces will be described with reference to FIG. 10. FIG. 10 is a flowchart showing the broadcast order determination process regarding wireless interfaces. The controller 103 of the transmission node finally determines the broadcast order with reference to the neighboring node wireless interface configuration table and the private node wireless interface configuration table, which is stored in the storage 104 and which is acquired by way of the wireless interface configuration acknowledgement processes.

The controller 103 of the transmission node sorts the regions of the private node interface configuration table stored in the storage 104 in an order of the large number of detected neighboring nodes; then, numbers “1”, “2”, . . . representing the places of the broadcast order are provisionally assigned to the regions of the private node wireless interface configuration table already subjected to sorting in the broadcast order in step S100. When multiple regions designate the same number of detected neighboring nodes, they are sorted such that the region having a larger number of nominated neighboring nodes is given a higher place in the broadcast order. When multiple regions designate the same number of detected neighboring nodes and the same number of nominated neighboring nodes, they are sorted in a random manner.

Next, the flow proceeds to step S200 in which a decision is made as to whether or not the controller 103 of the transmission node checks all the wireless interfaces, that is, a decision is made as to whether or not each of the wireless interfaces is presently available in transmission. Specifically, the controller 103 performs steps S210 to S300. When the controller 103 completely checks all the interfaces, the broadcast order determination process of FIG. 10 is ended.

When the controller 103 determines that it has not finished checking all the wireless interfaces, the flow proceeds to step S210 in which the controller 103 selects a wireless interface having the highest place of the broadcast order within the wireless interfaces unfinished in checking with reference to the private node wireless interface configuration table. In step S220, the controller 103 makes a decision as to whether or not “invalid” is described in the column of the reachable wireless interface in the neighboring node wireless interface configuration table stored in the storage 104. When the controller 103 determines in step S220 that the reachable wireless interface is not “invalid”, the flow proceeds to step S300. When the controller 103 determines in step S220 that the reachable wireless interface is not “invalid”, the flow proceeds to step S230 in which a decision is made as to whether or not the number of detected neighboring nodes is set to “1” or more with respect to the presently selected wireless interface in the private node wireless interface configuration table. When the controller 103 determines in step S230 that the number of detected neighboring nodes is not “1” or more, the flow proceeds to step S300.

When the controller 103 determines in step S230 that the number of detected neighboring nodes is “1” or more, the flow proceeds to step S240. In step S240, the controller 103 makes a decision as to whether or not it completely checks all the regions in the neighboring node wireless interface configuration table. When the controller 103 completely checks all the regions of the neighboring node wireless interface configuration table, the flow proceeds to step S250. When the controller 103 does not finish checking all the regions of the neighboring node wireless interface configuration table, the flow proceeds to step S241 in which the selects one of the unchecked regions in the neighboring node wireless interface configuration table.

After completion of step S241, the flow proceeds to step S242 in which the controller 103 makes a decision as to whether or not the selected region (which is selected in step S241 in the neighboring node wireless interface configuration table) satisfies all conditions dictating that the wireless interface configuration designates the selected wireless interface (selected in step S210), the connection status is “connected” for the selected wireless interface, and the reachable wireless interface is “invalid”. When the controller 103 determines in step S242 that the selected region does not satisfy all conditions, the flow returns to step S240. When the controller 103 determines in step S242 that the selected region satisfies all conditions, the flow proceeds to step S243 in which the selected wireless interface is registered as the reachable wireless interface in the selected region of the neighboring node wireless interface configuration table stored in the storage 104; then, the flow returns to step S240.

In step S250, the controller 103 makes a decision as to whether or not the selected wireless interface (selected in step S210) is registered as the reachable wireless interface in the neighboring node wireless interface configuration table stored in the storage 104. When the controller 103 determines in step S250 that the selected wireless interface is registered as the reachable wireless interface, the flow returns to step S200. When the controller 103 determines in step S250 that the selected wireless interface is not registered as the reachable wireless interface, the flow proceeds to step S251 in which the broadcast order regarding the selected wireless interface is “invalid” in the private node wireless interface configuration table; then, the flow returns to step S200. In step S300, the controller 103 describes “invalid” in the broadcast order of the private node wireless interface configuration table with regard to the selected wireless interface (selected in step S210) and the unselected wireless interface(s); then, the broadcast order determination process of FIG. 10 is ended.

In the present embodiment, different node identifiers are assigned to multiple nodes linked together via the network; beacon messages including node identifiers are transmitted to neighboring nodes; and nodes receiving beacon messages send back response messages including their own wireless interfaces. According to the aforementioned processes, the transmission node can acknowledge wireless interface configurations regarding neighboring nodes, then it performs broadcasting upon determination whether to use wireless interfaces causing duplication of data. Thus, it is possible to achieve broadcast transmission reaching all neighboring nodes without causing duplication of data.

Next, an example of broadcasting suiting requirements will be described in connection with broadcast requests from high-order layers. For example, flooding of ad hoc routing requires that broadcast packets reach neighboring nodes via any wireless interface. Hereinafter, this operation will be referred as “usage 1”. In this case, the transmitter 101 performs broadcasting using one of wireless interfaces, which are not invalid in the broadcast order of the private node wireless interface configuration table stored in the storage 104. This makes it possible to perform broadcasting with efficient usage of frequency minimizing duplication of data while reliably making packets reach all neighboring nodes.

Flooding of ad hoc routing does not require packets to reach all neighboring nodes subjected to broadcasting but requires packets to reach a certain number of neighboring nodes. Hereinafter, this operation will be referred to as “usage 2”. In this case, the transmission node performs broadcasting such that packets are not transmitted to all neighboring nodes but to N nodes which are designated in advance by way of steps S1 to S3 (which will be described below without using a flowchart). The following description refers to a term “reachable sum S” representing the number of reachable nodes, to which packets can reach via a wireless interface selected in step S1. The initial value of the reachable sum S is set to zero.

In step S1, the controller 103 selects a wireless interface whose broadcast order is highest within wireless interfaces not selected in step S2 with reference to the neighboring node wireless interface configuration table. In step S2, the controller 103 adds the number of reachable nodes, to which packets can reach via the selected wireless interface (selected in step S1), i.e. the number of detected neighboring nodes in the private node wireless interface configuration table stored in the storage 104, to the reachable sum S. In step S3, the controller 103 makes a decision as to whether or not the reachable sum S calculated in step S2 is N or more. When the reachable sum S is smaller than N, the flow returns to step S1. When the reachable sum S is N or more, the transmitter 101 performs broadcasting using the selected wireless interface (selected in step S1). This makes it possible to perform broadcasting with efficient usage of frequency minimizing duplication of data while ensuring packets reach N or more nodes, which are designated in advance.

Broadcasting can be performed using all wireless interfaces in order to check neighboring conditions with respect to all wireless interfaces. Hereinafter, this operation will be referred to as “usage 3”. In this case, the transmitter 101 performs broadcasting using wireless interfaces in which the number of nominated neighboring nodes is “1” or more in the neighboring wireless interface configuration table stored in the storage 104. This prevents wireless interfaces, which are not at all used by neighboring nodes, from being used in broadcasting; hence, it is possible to perform broadcasting using wireless interfaces, which are used by neighboring nodes.

### 3. Operation

(A) First Operation

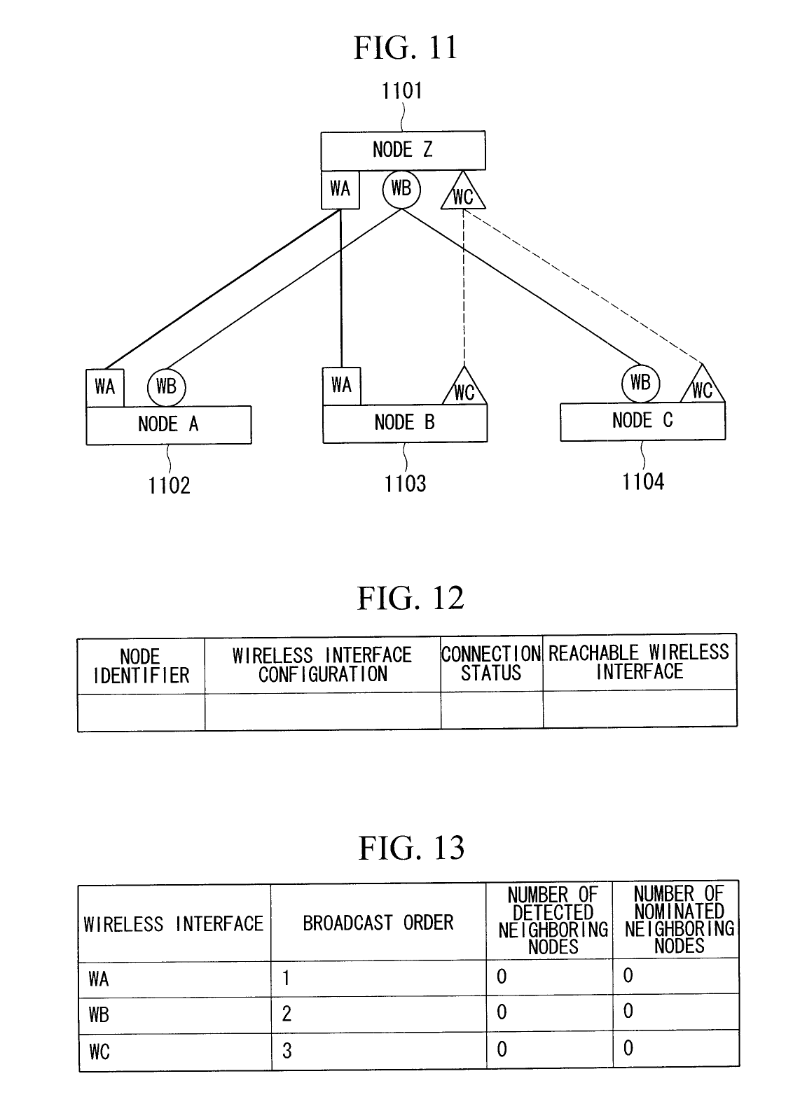

Next, a first operation will be described with reference to FIGS. 11 to 19. FIG. 11 shows an example of a network system including four nodes, namely, a node 1101 (referred to as a node Z), a node 1102 (referred to as a node A), a node 1103 (referred to as a node B), and a node 1104 (referred to as a node C). The first operation is performed just after start-up of the node 1101 serving as a multicast transmission node (or a multicast transmission source). The nodes 1102, 1103, and 1104 receive multicast data transmitted from the node 1101. The node 1101 has three wireless interfaces suiting three types of wireless communication methods, namely, WA, WB, and WC. The node 1102 has two wireless interfaces suiting two types of wireless communication methods, namely, WA and WB. The node 1103 has two wireless interfaces suiting two types of wireless communication methods, namely, WA and WC. The node 1104 has two wireless interfaces suiting two types of wireless communication methods, namely, WB and WC. The nodes 1101 to 1104 have “directly recognizable” node identifiers. Specifically, the node 1101 has a node identifier Z; the node 1102 has a node identifier A; the node 1103 has a node identifier B; and the node 1104 has a node identifier C.

Next, wireless interface configuration acknowledgement processes will be described in accordance with the first operation. FIG. 12 shows a neighboring node wireless interface configuration table stored in the storage 104 of the node 1101 in accordance with the first operation. The neighboring node wireless interface configuration table defines four attributes, i.e. node identifiers, wireless interface configurations, connection statuses, and reachable wireless interfaces. One region of this table describes information with regard to one node. Since the first operation is performed just after start-up of the node 1101, all regions of the neighboring node wireless interface configuration table are blank.

FIG. 13 shows a private node wireless interface configuration table stored in the storage 104 of the node 1101. The private node wireless interface configuration table defines four attributes, i.e. wireless interfaces, broadcast orders, numbers of detected neighboring nodes, and numbers of nominated neighboring nodes. One region of this table describes information with regard to one wireless interface. FIG. 13 shows three regions included in the private node wireless interface configuration table. In the first region regarding the wireless interface WA, the broadcast order is “1”, the number of detected neighboring nodes is “0”, and the number of nominated neighboring nodes is “0”. In the second region regarding the wireless interface WB, the broadcast order is “2”, the number of detected neighboring nodes is “0”, and the number of nominated neighboring nodes is “0”. In the third region regarding the wireless interface WC, the broadcast order is “3”, the number of detected neighboring nodes is “0”, the number of nominated neighboring nodes is “0”. Since the first operation is performed just after start-up of the node 1101, the broadcast order is provisionally determined in the alphabetic order of the wireless interfaces WA, WB, and WC. The broadcast order just after start-up of the node 1101 can be determined in a random manner.

Next, wireless interface configuration acknowledgement processes, which are performed by a transmission node (i.e. the node 1101) and a reception node in accordance with the first operation, will be described with reference to FIGS. 5 and 7. FIG. 5 shows the wireless interface configuration acknowledgement process performed by the transmission node, and FIG. 7 shows the wireless interface configuration acknowledgement process performed by the reception node. The transmitter 101 of the node 1101 broadcasts beacon messages via wireless interfaces sequentially selected based on the broadcast order in the private node wireless interface configuration table stored in the storage 104; then, it waits for a prescribed time after broadcasting in step S11. Since the first operation is performed just after start-up of the node 1101, the sequence number of the beacon message is set to “1”.

In step S21, the receiver 102 of the node 1102 receives the beacon message broadcast by the node 1101. In this case, the beacon management table stored in the storage 104 of the node 1102 does not include the combination of the node identifier Z and the sequence number “1” included in the beacon message; hence, the node 1102 determines in step S22 that no response message is sent back to the node 1101. Thus, the flow proceeds to step S24 in which the transmitter 101 of the node 1102 performs unicast transmission so as to send back a response message sending the node identifier A and the wireless interfaces WA and WB to the node 1101; then, the beacon management table of the storage 104 of the node 1102 stores the node identifier Z and the sequence number “1”.

The receiver 102 of the node 1103 receives the beacon message from the node 1101 substantially at the same timing the node 1102 receives the beacon message. The beacon management table of the storage 104 of the node 1103 does not store the combination of the node identifier Z and the sequence number “1” included in the beacon message; hence, the node 1103 determines in step S22 that no response message is sent back to the node 1101. Then, the flow proceeds to step S24 in which the transmitter 101 of the node 1103 performs unicast transmission so as to send back a response message sending the node identifier B and the wireless interfaces WA and WC to the node 1101; then, the beacon management table of the storage 104 of the node 1103 stores the node identifier Z and the sequence number “1”.

The receiver 102 of the node 1101 receives the response message sent by the transmitter 101 of the node 1102 during the prescribed wait time; hence, the flow proceeds from step S12 to step S13. In step S13, the wireless interface configuration designates WA and WB, the connection status is “connected” for WA and “disconnected” for WB, the reachable wireless interface is “invalid” with respect to the node identifier A in the neighboring node wireless interface configuration table of the storage 104. In addition, “1” is added to the number of detected neighboring nodes and the number of nominated neighboring nodes, both of which are initially set to “0”, with respect to the wireless interface WA. Furthermore, “1” is added to the number of nominated neighboring nodes, which is initially set to “0”, with respect to the wireless interface WB. That is, in the private node wireless interface configuration table of the storage 104 of the node 1101, both the number of detected neighboring nodes and the number of nominated neighboring nodes are set to “1” with respect to the wireless interface WA, while the number of nominated neighboring nodes is set to “1” with respect to the wireless interface WB.

The receiver 102 of the node 1101 also receives the response message sent by the transmitter 101 of the node 1103; hence, the flow proceeds from step S12 to step S13. In step S13, the wireless interface configuration designates WA and WC, the connection status is “connected” for WA and “disconnected” for WB in the connection status, and the reachable wireless interface is “invalid” with respect to the node identifier B in the neighboring node wireless interface configuration table of the storage 104. In addition, “1” is added to both the number of detected neighboring nodes and the number of nominated neighboring nodes, both of which are presently set to “1”, with respect to the wireless interface WA. Furthermore, “1” is added to the number of nominated neighboring nodes, which is initially set to “0”, with respect to the wireless interface WC. That is, in the private node wireless interface configuration table of the storage 104 of the node 1101, both the number of detected neighboring nodes and the number of nominated neighboring nodes are set to “2” with respect to the wireless interface WA, while the number of nominated neighboring nodes is set to “1” with respect to the wireless interface WC.

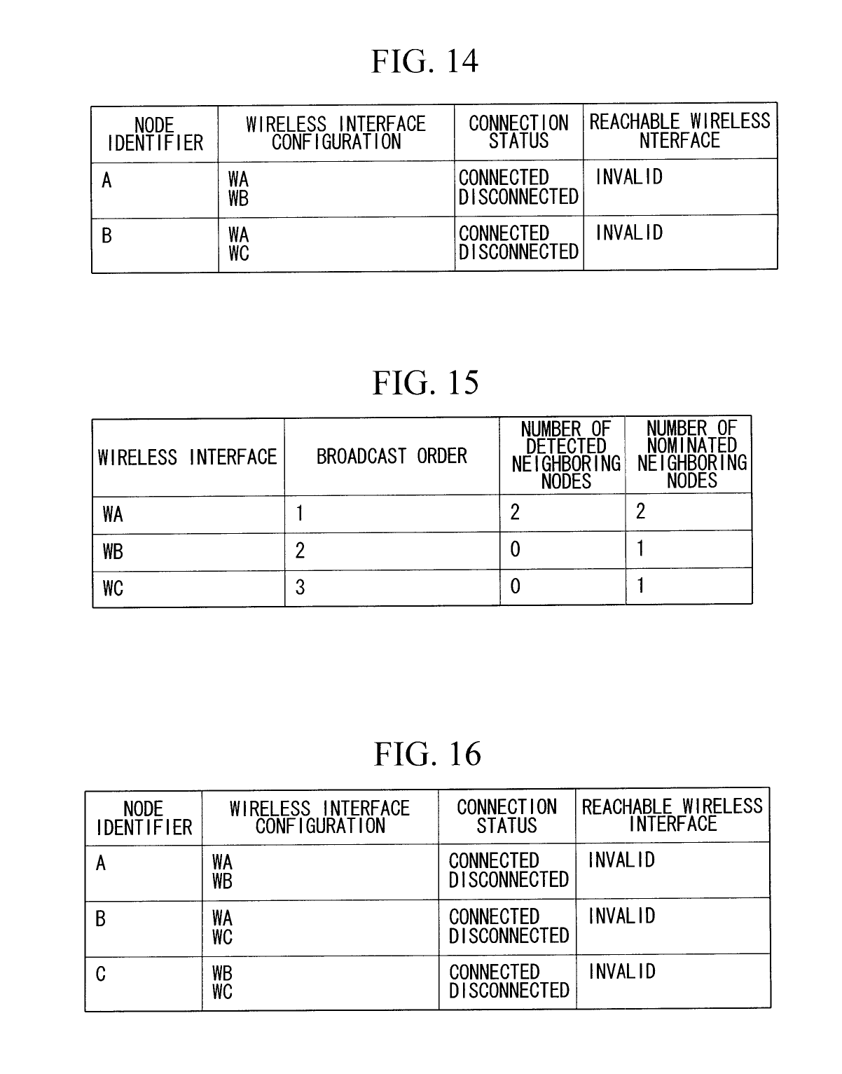

FIG. 14 shows the content of the neighboring node wireless interface configuration table of the storage 104 of the node 1101 at the present timing. In the neighboring node wireless interface configuration table of FIG. 14, the first region regarding the node identifier A lists WA and WB in the wireless interface configuration, wherein the connection status is “connected” for WA and “disconnected” for WB, and the reachable wireless interface is “invalid”. The second region regarding the node identifier B lists WA and WC in the wireless interface configuration, wherein the connection status is “connected” for WA and “disconnected” for WC, and the reachable wireless interface is “invalid”.

FIG. 15 shows the content of the private node wireless interface configuration table of the storage 104 of the node 1101 at the present timing. In the first region regarding the wireless interface WA of the private node wireless interface configuration table of FIG. 15, the broadcast order is “1”, the number of detected neighboring nodes is “2”, and the number of nominated neighboring nodes is “2”. In the second region regarding the wireless interface WB, the broadcast order is “2”, the number of detected neighboring nodes is “0”, and the number of nominated neighboring nodes is “1”. In the third region regarding the wireless interface WC, the broadcast order is “3”, the number of detected neighboring nodes is “0”, and the number of nominated neighboring nodes is “1”.

In step S15, the controller 103 of the node 1101 determines that broadcasting is not performed using the wireless interfaces WB and WC; hence, the flow returns to step S11. The transmitter 101 of the node 1101 broadcast beacon messages via the wireless interface WB based on the broadcast order stored in the private node wireless interface configuration table; then, it stops transmission for the prescribed wait time. Since the foregoing processing is still running, the sequence number included in the beacon message is “1”.

In step S21, the receiver 102 of the node 1102 receives the beacon message broadcast by the transmitter 101 of the node 1101. Since the combination of the node identifier Z and the sequence number “1” included in the beacon message is already stored in the beacon management table of the storage 104 of the node 1102, the controller 103 determines in step S22 that the response message has already been sent back to the node 1101. In step S23, the receiver 102 of the node 1102 discards the received beacon message.

The receiver 102 of the node 1104 also receive the beacon message substantially at the same timing the receiver 102 of the node 1102 receives the beacon message; hence, the flow proceeds from step S21 to step S22 with respect to the node 1104. Since the combination of the node identifier Z and the sequence number “1” included in the beacon message is not stored in the beacon management table of the storage 104 of the node 1104, the controller 103 determines in step S22 that no response message is sent back to the node 1101; hence, the flow proceeds to step S24. The transmitter 101 of the node 1104 performs unicast transmission so as to send the response message sending the node identifier C and the wireless interfaces WB and WC to the node 1101; then, the node identifier Z and the sequence number “1” are stored in the beacon management table of the storage 104.

The receiver 102 of the node 1101 receives the response message sent by the transmitter 101 of the node 1104 during the prescribed wait time; hence, the flow proceeds from step S12 to step S13 with respect to the node 1101. With respect to the node identifier C, the wireless interface configuration lists WB and WC, the connection status is “connected” for WB and “disconnected” for WC, and the reachable wireless interface is “invalid” in the neighboring node wireless interface configuration table of the storage 104 of the node 1101. In addition, “1” is added to the number of detected neighboring nodes and the number of nominated neighboring nodes, both of which are initially set to “0”, with respect to the wireless interface WB. Furthermore, “1” is added to the number of nominated neighboring nodes, which is previously set to “1”, with respect to the wireless interface WC. That is, in the private node wireless interface configuration table of the storage 104 of the node 1101, both the number of detected neighboring nodes and the number of nominated neighboring nodes are updated to “1” with respect to the wireless interface WB, while the number of nominated neighboring nodes is updated to “2” with respect to the wireless interface WC.

FIG. 16 shows the content of the neighboring node wireless interface configuration table of the storage 104 of the node 1101 at the present timing. With respect to the node identifier A, the wireless interface configuration lists WA and WB, the connection status is “connected” for WA and “disconnected” for WB, and the reachable wireless interface is “invalid”. With respect to the node identifier B, the wireless interface configuration lists WA and WC, the connection status is “connected” for WA and “disconnected” for WC, and the reachable wireless interface is “invalid”. With respect to the node identifier C, the wireless interface configuration lists WB and WC, the connection status is “connected” for WB and “disconnected” for WC, and the reachable wireless interface is “invalid”.

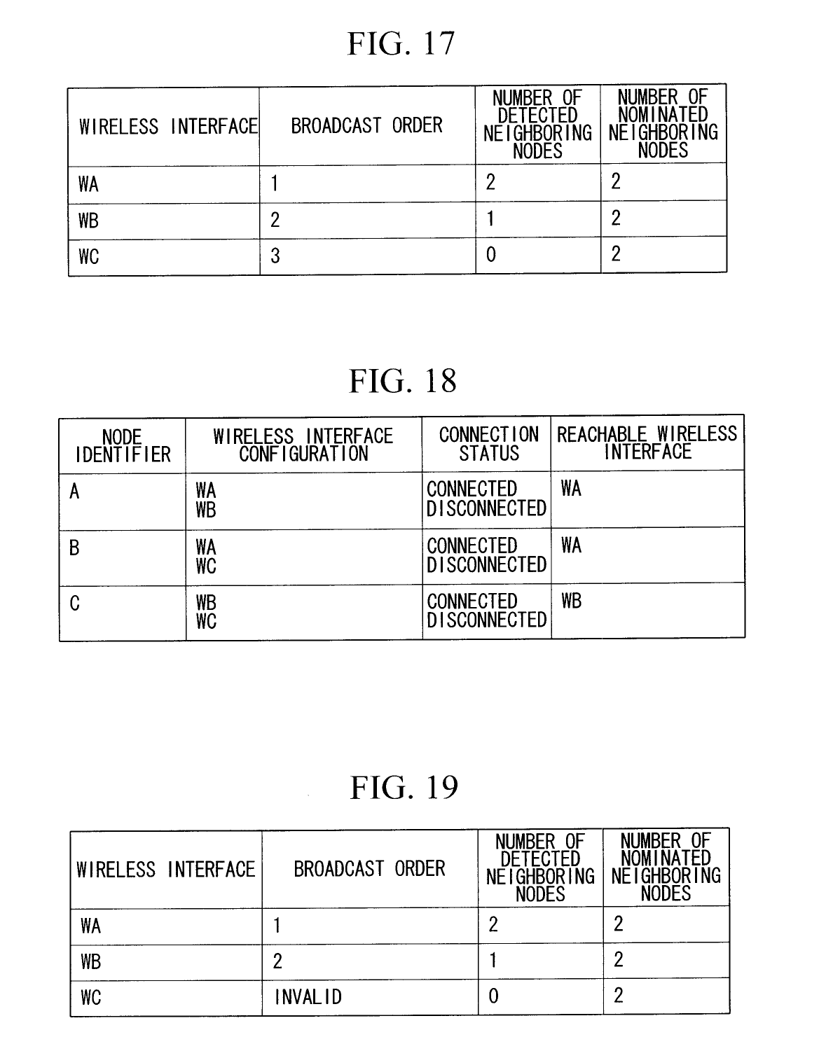

FIG. 17 shows the content of the private node wireless interface configuration table of the storage 104 of the node 1101 at the present timing. With respect to the wireless interface WA, the broadcast order is “1”, the number of detected neighboring nodes is “2”, and the number of nominated neighboring nodes is “2”. With respect to the wireless interface WB, the broadcast order is “2”, the number of detected neighboring nodes is “1”, the number of nominated neighboring nodes is “2”. With respect to the wireless interface WC, the broadcast order is “3”, the number of detected neighboring nodes is “0”, and the number of nominated neighboring nodes is “2”

Next, the controller 103 of the node 1101 determines in step S15 that broadcasting is not performed using the wireless interface WC; hence, the flow proceeds to step S11. The transmitter 101 of the node 1101 broadcasts beacon messages via the wireless interface WC based on the broadcast order of the private node wireless interface configuration table stored in the storage 104. Since the foregoing processing is still running, the sequence number is still set to “1”.

The receiver 102 of the node 1103 receives the beacon message broadcast by the transmitter 101 of the node 1101; hence, the flow proceeds from step S21 to S22 with respect to the node 1103. Since the beacon management table of the storage 104 of the node 1103 has already been stored the combination of the node identifier Z and the sequence number “1”, the controller 103 determines in step S22 that the response message has already been sent back to the node 1101. In step S23, the receiver 102 of the node 1103 discards the received beacon message.

The receiver 102 of the node 1104 also receives the beacon message broadcast by the transmitter 101 of the node 1101 substantially at the same timing the receiver 102 of the node 1103 receives the beacon message; hence, the flow proceeds from step S21 to step S22 with respect to the node 1104. Since the storage 104 of the node 1104 has already been stored the combination of the node identifier Z and the sequence number “1”, the controller 103 determines in step S22 that the response message has already been sent back to the node 1101. In step S23, the receiver 102 of the node 1104 discards the received beacon message.

Due to the aforementioned procedures, the receiver 102 of the node 1101 does not receive any response message during the prescribed wait time; hence, the flow proceeds from step S12 to step S14 with respect to the node 1101. In step S14, the number of detected neighboring nodes is set to “0” with respect to the wireless interface WC in the private node wireless interface configuration table of the storage 104 of the node 1101. The controller 103 of the node 1101 determine s in step S15 that broadcasting is completely performed using all the wireless interfaces WA, WB, and WC; thus, the wireless interface configuration acknowledgement process is ended. At this time, the same content shown in FIG. 14 is retained in the neighboring node wireless interface configuration table of the storage 104 of the node 1101. Similarly, the same content shown in FIG. 15 is retained in the private node wireless interface configuration table of the storage 104 of the node 1101.

In connection with the aforementioned first operation, the broadcast order determination process will be described with reference to FIG. 10. In step S100, the controller 103 of the node 1101 sorts the regions of the private node wireless interface configuration table of the storage 104 in the order of larger numbers of detected neighboring nodes, thus provisionally assigning places of the broadcast order to the wireless interfaces. With respect to the number of detected neighboring nodes, the private node wireless interface configuration table stores “2” for WA, “1” for WB, and “0” for WC; that is, the broadcast order is provisionally determined in the order of WA, WB, and WC. As the broadcast order, “1” is assigned to the wireless interface WA; “2” is assigned to the wireless interface WB; and “3” is assigned to the wireless interface WC.

Next, the controller 103 of the node 1101 determines in step S200 that examination is not completed with respect to all the wireless interfaces. In step S210, the controller 103 of the node 1101 selects the wireless interface WA whose broadcast order is “1” first. In step S220, the controller 103 of the node 1101 determines that the reachable wireless interface is “invalid” with reference to the neighboring node wireless interface configuration table of the storage 104. In step S230, it determines that the number of detected neighboring nodes is “1” or more with respect to the wireless interface WA with reference to the private node wireless interface configuration table of the storage 104. Then, the flow proceeds to step S240.

In step S240, the controller 103 of the node 1101 determines that examination is not completed with respect to all the regions of the neighboring node, wireless interface configuration table. In step S241, it selects the region of the node identifier A, which is not examined, with reference to the neighboring node wireless interface configuration table. In step S242, the controller 103 of the node 1101 determines that the region of the node identifier A (selected in step S241) satisfies all the prescribed conditions dictating the wireless interface configuration lists WA, the connection status is “connected” for WA, the reachable wireless interface is “invalid” in the neighboring node wireless interface configuration table; hence, the flow proceeds to step S243. In the region of the node identifier A of the neighboring node wireless interface configuration table, the controller 103 of the node 1101 lists the wireless interface WA as the reachable wireless interface. Then, the flow returns to step S240.

In step S240, the controller 103 of the node 1101 determines that examination has not been completed with respect to the regions of the node identifiers B and C in the neighboring node wireless interface configuration table of the storage 104. In step S241, it selects the region of the node identifier B, which is not examined, with reference to the neighboring node wireless interface configuration table. In step S242, the controller 103 of the node 1101 determines that the region of the node identifier B (selected in step S241) satisfies all the prescribed conditions dictating that the wireless interface configuration lists WA (selected in step S210), the connection status is “connected” for WA, and the reachable wireless interface is “invalid” in the neighboring node wireless interface configuration table. In step S243, the wireless interface WA is designated as the reachable wireless interface with respect to the node identifier B in the neighboring node wireless interface configuration table. Then, the flow returns to step S240.

In step S240, the controller 103 of the node 1101 determines that the region of the node identifier C has not been examined with reference to the neighboring node wireless interface configuration table of the storage 104. In step S241, it selects the region of the node identifier C, which is not examined in the neighboring node wireless interface configuration table. In step S242, the controller 103 of the node 1101 determines that the wireless interface WA (selected in step S210) is not listed in the region of the node identifier C in the neighboring node wireless interface configuration table; hence, the flow returns to step S240.

In step S240, the controller 103 of the node 1101 determines that examination has not been completed with respect to all the regions of the neighboring node wireless interface configuration table; hence, the flow proceeds to step S250. In step S205, it determines that the wireless interface WA is designated as the reachable wireless interface in the neighboring node wireless interface configuration table; hence, the flow returns to step S200. In step S200, the controller 103 of the node 1101 determines that examination has not been completed with respect to the wireless interfaces WB and WC. In step S210, it selects the wireless interface WB whose broadcast order is “2” to be examined. In step S220, the controller 103 of the node 1101 determines that the reachable wireless interface is “invalid” with reference to the region of the node identifier C of the neighboring node wireless interface configuration table; hence, the flow proceeds to step S230. In step S230, it determines that the number of detected neighboring nodes is “1” or more with respect to the selected wireless interface WB with reference to the private node wireless interface configuration table; hence, the flow proceeds to step S240.

In step S240, the controller 103 of the node 1101 determines that examination has not been completed with respect to all the regions of the neighboring node wireless interface configuration table of the storage 104. In step S241, it selects the region of the node identifier A, which is not examined in the neighboring node wireless interface configuration table. In step S242, the controller 103 of the node 1101 determines that the region of the node identifier A (selected in step S241) does not satisfy all the prescribed conditions dictating that the wireless interface configuration lists WA (selected in step S210), the connection status is “connected” for WB, and the reachable wireless interface is “invalid”. Then, the flow returns to step S240.

In step S240, the controller 103 of the node 1101 determines that examination has not been completed with respect to the regions of the node identifiers B and C in the neighboring node wireless interface configuration table of the storage 104. In step S241, it selects the region of the node identifier B, which is not examined in the neighboring node wireless interface configuration table. In step S242, the controller 103 of the node 1101 determines that the region of the node identifier B (selected in step S241) does not satisfy all the prescribed conditions dictating that the wireless interface configuration lists WB (selected in step S210), the connection status is “connected” for WB, and the reachable wireless interface is “invalid” in the neighboring node wireless interface configuration table; hence, the flow returns to step S240.

In step S240, the controller 103 of the node 1101 determines that the region of the node identifier C has not been examined in the neighboring node wireless interface configuration table of the storage 104. In step S241, it selects the region of the node identifier C, which is not examined in the neighboring node wireless interface configuration table. In step S242, the controller 103 of the node 1101 determines that the region of the node identifier C (selected in step S241) satisfies all the prescribed conditions dictating that the wireless interface configuration lists WB (selected in step S210), the connection status is “connected” for WB, and the reachable wireless interface is “invalid”; hence, the flow proceeds to step S243. In step S243, the controller 103 of the node 1101 designates the wireless interface WB as the reachable wireless interface in the neighboring node wireless interface configuration table of the storage 104; then, the flow returns to step S240.

In step S240, the controller 103 of the node 1101 determines that examination has not been completed with respect to all the regions of the node identifiers in the neighboring node wireless interface configuration table; hence, the flow proceeds to step S250. In step S250, it determines that the wireless interface WB is designated as the reachable wireless interface in the neighboring node wireless interface configuration table; hence, the flow returns to step S200. In step S200, the controller 103 of the node 1101 determines that examination has not been completed with respect to the wireless interface WC. In step S210, it selects the wireless interface WC whose priority order is “3” to be examined. In step S220, the controller 103 of the node 1101 determines that the reachable wireless interface is not “invalid” in the neighboring node wireless interface configuration table; hence, the flow proceeds to step S300. In step S300, the controller 103 of the node 1101 changes the broadcast order of the wireless interface WC (selected in step S210) to “invalid” in the private node wireless interface configuration table of the storage 104. Thus, the broadcast order determination process is completed.

FIG. 18 shows the content of the neighboring node wireless interface configuration table stored in the storage 104 of the node 1101 at the present timing. In the region of the node identifier A, the wireless interface configuration lists WA and WB, the connection status is “connected” for WA and “disconnected” for WB, and WA is designated as the reachable wireless interface. In the region of the node identifier B, the wireless interface configuration lists WA and WC, the connection status is “connected” for WA and “disconnected” for WC, and WA is designated as the reachable wireless interface. In the region of the node identifier C, the wireless interface configuration lists WB and WC, the connection status is “connected” for WB and “disconnected” for WC, and WB is designated as the reachable wireless interface.

FIG. 19 shows the content of the private node wireless interface configuration table, which is stored in the storage 104 of the node 1101 at the present timing. With respect to the wireless interface WA, the broadcast order is “1”, the number of detected neighboring nodes is “2”, and the number of nominated neighboring nodes is “2”. With respect to the wireless interface WB, the broadcast order is “2”, the number of detected neighboring nodes is “1”, and the number of nominated neighboring nodes is “2”. With respect to the wireless interface WC, the broadcast order is “invalid”, the number of detected neighboring nodes is “0”, and the number of nominated neighboring nodes is “2”.

As described above, the present embodiment is designed to appropriately update the content of the neighboring node wireless interface configuration table and the content of the private node wireless interface configuration table in accordance with the aforementioned processes. In the usage 1, it is possible to perform broadcasting using only the wireless interfaces WA and WB whose broadcast orders are “1” and “2” at an efficient usage of frequency minimizing duplication of data while ensuring packets to reach all the nodes. In the usage 2 in which the number of nodes to be reached is set to “2”, for example, it is possible to perform broadcasting using only the wireless interface WA at an efficient usage of frequency minimizing duplication of data while ensuring packets reach two nodes. In the usage 3, broadcasting is performed using the wireless interfaces WA, WB, and WC in which the number of nominated neighboring nodes is “1” or more; thus, it is possible to perform effective broadcasting reaching all the nodes while avoiding unnecessary broadcasting.

(B) Second Operation

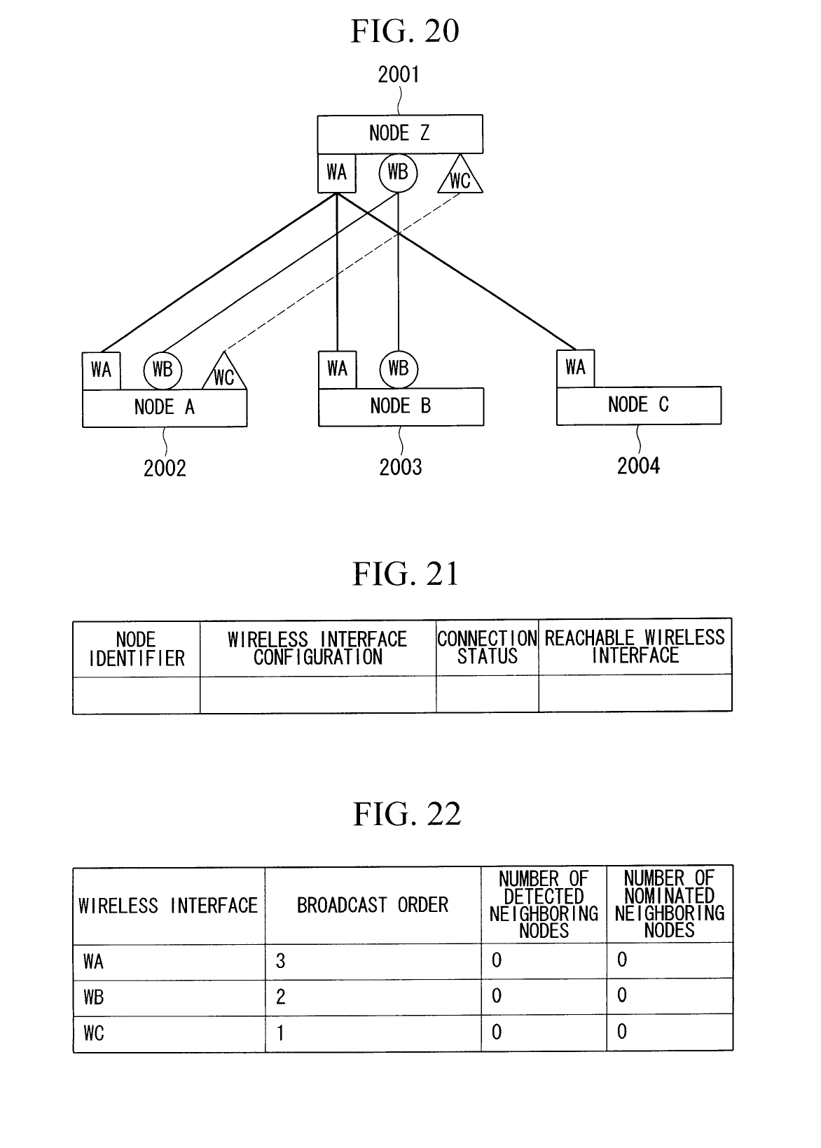

Next, a second operation will be described with reference to FIGS. 20 to 30. The second operation is performed just after start-up of the multicast transmission node. FIG. 20 shows the network system including four nodes, namely, a node 2001 (referred to as a node Z), a node 2002 (referred to as a node A), a node 2003 (referred to as a node B), and a node 2004 (referred to as a node C). The node 2001 serves as the multicast transmission node. The nodes 2002 to 2004 receive multicast data transmitted from the node 2001. Specifically, the node 2001 has three wireless interfaces suiting three types of wireless communication methods, i.e. WA, WB, and WC. The node 2002 has three wireless interfaces suiting three types of wireless communication methods, i.e. WA, WB, and WC. The node 2003 has two wireless interfaces suiting two types of wireless communication methods, i.e. WA and WB. The node 2004 has one wireless interface suiting one wireless communication method, i.e. WA. All the nodes 2001 to 2004 have “directly recognizable” node identifiers. That is, the node 2001 has the node identifier Z; the node 2002 has the node identifier A; the node 2003 has the node identifier B; and the node 2004 has the node identifier C.

In connection with the second operation, the wireless interface configuration acknowledgement processes will be described with reference to FIGS. 5 and 7. FIG. 21 shows a neighboring node wireless interface configuration table initially stored in the storage 104 of the node 2001 in accordance with the second operation. The neighboring node wireless interface configuration table defines various attributes, i.e. node identifiers, wireless interface configurations, connection statuses, and reachable wireless interfaces. One region of this table stores information of one node. The table of FIG. 21 is established just after start-up of the node 2001; hence, it is blank.

FIG. 22 shows a private node wireless interface configuration table initially stored in the storage 104 of the node 2001 in accordance with the second operation. The private node wireless interface configuration table defines various attributes, i.e. wireless interfaces, broadcast orders, numbers of detected neighboring nodes, and numbers of nominated neighboring nodes. One region of this table stores information of one wireless interface. The table of FIG. 22 includes three regions with respect to the wireless interfaces WA, WB, and WC. In the region of the wireless interface WA, the broadcast order is “3”, the number of detected neighboring nodes is “0”, and the number of nominated neighboring nodes “0”. In the region of the wireless interface WB, the broadcast order is “2”, the number of detected neighboring nodes is “0”, and the number of nominated neighboring nodes is “0”. In the region of the wireless interface WC, the broadcast order is “1”, the number of detected neighboring nodes is “0”, and the number of nominated neighboring nodes is “0”. Since the table of FIG. 22 is established just after start-up of the node 2001, the broadcast order is determined in a random manner. The broadcast order can be initially determined in the alphabetic order of the wireless interfaces WA, WB, and WC.

Next, the wireless interface configuration acknowledgement processes at the transmission node (i.e. the node 2001) and the reception node (i.e. the nodes 2002 to 2004) will be described with reference to FIGS. 5 and 7. The transmitter 101 of the node 2001 performs broadcasting using the wireless interface WC (which is selected based on the broadcast order of the private node wireless interface configuration table shown in FIG. 22) so as to transmit beacon messages; then, it stops transmission for a prescribed wait time in step S11. Just after start-up of the node 2001, the sequence number included in the beacon message is initially set to “1”.

The receiver 102 of the node 2002 receives the beacon message broadcast by the transmitter 101 of the node 2001 in step S21. Since the controller 103 of the node 2002 determines that the beacon management table stored in the storage 104 does not store the combination of the node identifier Z and the sequence number “1”, it determines in step S22 that no response message is sent back to the node 2001. In step S24, the transmitter 101 of the node 2002 performs unicast transmission so as to send the response message describing the node identifier A and the wireless interfaces WA, WB, and WC to the node 2001; then, the node identifier Z and the sequence number “1” are registered with the beacon management table of the storage 104.

In step S12, the receiver 102 of the node 2001 receives the response message transmitted by the transmitter 101 of the node 2002 during the prescribed wait time; hence, the flow proceeds to step S13. In the region of the node identifier A of the neighboring node wireless interface configuration table stored in the storage 104 of the node 2001, the wireless interface configuration lists WA, WB, and WC, the connection status is “disconnected” for WA and WB and “connected” for WC, and the reachable wireless interface is “invalid”. In addition, “1” is added to the number of detected neighboring nodes and the number of nominated neighboring nodes, both of which are initially set to “0”, with respect to the wireless interface WC in the private node wireless interface configuration table stored in the storage 104 of the node 2001; hence, both the number of detected neighboring nodes and the number of nominated neighboring nodes are set to “1” with respect to the wireless interface WC. Furthermore, “1” is added to the number of nominated neighboring nodes, which is initially set to “0”, with respect to both the wireless interfaces WA and WB in the private node wireless interface configuration table of the storage 104 of the node 2001; hence, the number of nominated neighboring nodes is set to “1” with respect to both the wireless interfaces WA and WB.

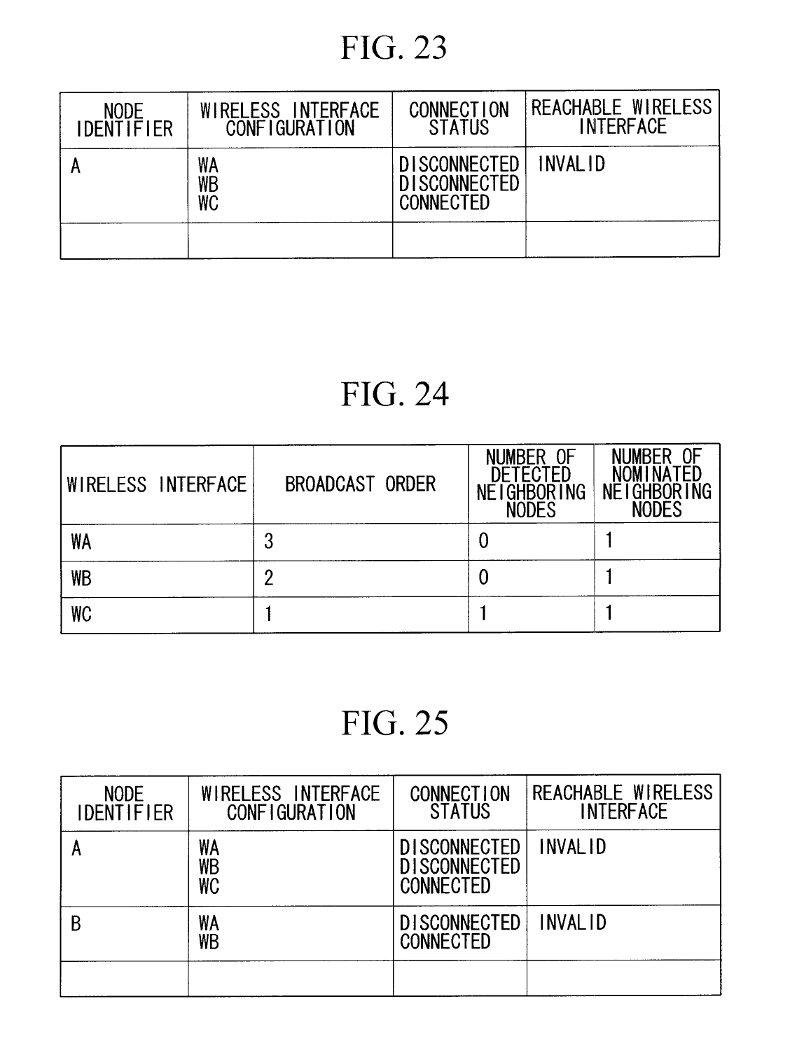

FIG. 23 shows the content of the neighboring node wireless interface configuration table, which is stored in the storage 104 of the node 2001 at the present timing. In the region of the node identifier A, the wireless interface configuration lists WA, WB, and WC, the connection status is “disconnected” for WA and WB and “connected” for WC, and the reachable wireless interface is “invalid”.

FIG. 24 shows the content of the private node wireless interface configuration table, which is stored in the storage 104 of the node 2001 at the present timing. With respect to the wireless interface WA, the broadcast order is “3”, the number of detected neighboring nodes is “0”, and the number of nominated neighboring nodes is “1”. With respect to the wireless interface WB, the broadcast order is “2”, the number of detected neighboring nodes is “0”, and the number of nominated neighboring nodes is “1”. With respect to the wireless interface WC, the broadcast order is “1”, the number of detected neighboring nodes is “1”, and the number of nominated neighboring nodes is “1”.

Next, the controller 103 of the node 2001 determines in step S15 that broadcasting is not performed using the wireless interfaces WA and WB; hence, the flow returns to step S11. In step S11, the transmitter 101 of the node 2001 broadcasts beacon messages via the wireless interface WB, which is selected based on the broadcast order of the private node wireless interface configuration table; then, it stops transmission for the prescribed wait time. Since the foregoing processing is still running, the sequence number included in the beacon message is “1”.

In step S21, the receiver 102 of the node 2002 receives the beacon message broadcast by the transmitter 101 of the node 2001. Since the combination of the node identifier Z and the sequence number “1” is already registered with the beacon management table of the storage 104 of the node 2002, the controller 103 determines in step S22 that the response message has been already sent back to the node 2001. In step S23, the receiver 102 of the node 2002 discards the received beacon message.

In step S21, the receiver 102 of the node 2003 also receives the beacon message broadcast by the transmitter 101 of the node 2001 substantially at the same timing the receiver 102 of the node 2002 receives the beacon message. Since the combination of the node identifier Z and the sequence number “1” is not registered with the beacon management table of the storage 104 of the node 2003, the controller 103 determines in step S22 that no response message is sent back to the node 2001. In step S24, the transmitter 101 of the node 2003 performs unicast transmission so as to send the response message sending the node identifier B and the wireless interfaces WA and WB to the node 2001; then, the node identifier Z and the sequence number “1” are registered with the beacon management table of the storage 104.

The receiver 104 of the node 2001 receives the response message sent by the node 2003 during the prescribed wait time; hence, the flow proceeds from step S12 to step S13. In the region of the node identifier B of the neighboring node wireless interface configuration table stored in the storage 104 of the node 2001, the wireless interface configuration lists WA and WB, the connection status is “disconnected” for WA and “connected” for WB, and the reachable wireless interface is “invalid”. With respect to the wireless interface WB in the private node wireless interface configuration table stored in the storage 104 of the node 2001, “1” is added to the number of detected neighboring nodes and the number of nominated neighboring nodes, both of which are initially set to “0”; hence, both the number of detected neighboring nodes and the number of nominated neighboring nodes are set to “1”. With respect to the wireless interface WA, “1” is added to the number of nominated neighboring nodes, which is presently set to “1”; hence, the number of nominated neighboring nodes is set to “2”.

FIG. 25 shows the content of the neighboring node wireless interface configuration table, which is stored in the storage 104 of the node 2001 at the present timing. In the region of the node identifier A, the wireless interface configuration lists WA, WB, and WC, the connection status is “disconnected” for WA and WB and “connected” for WC, and the reachable wireless interface is “invalid”. In the region of the node identifier B, the wireless interface configuration lists WA and WB, the connection status is “disconnected” for WA and “connected” for WB, and the reachable wireless interface is “invalid”.

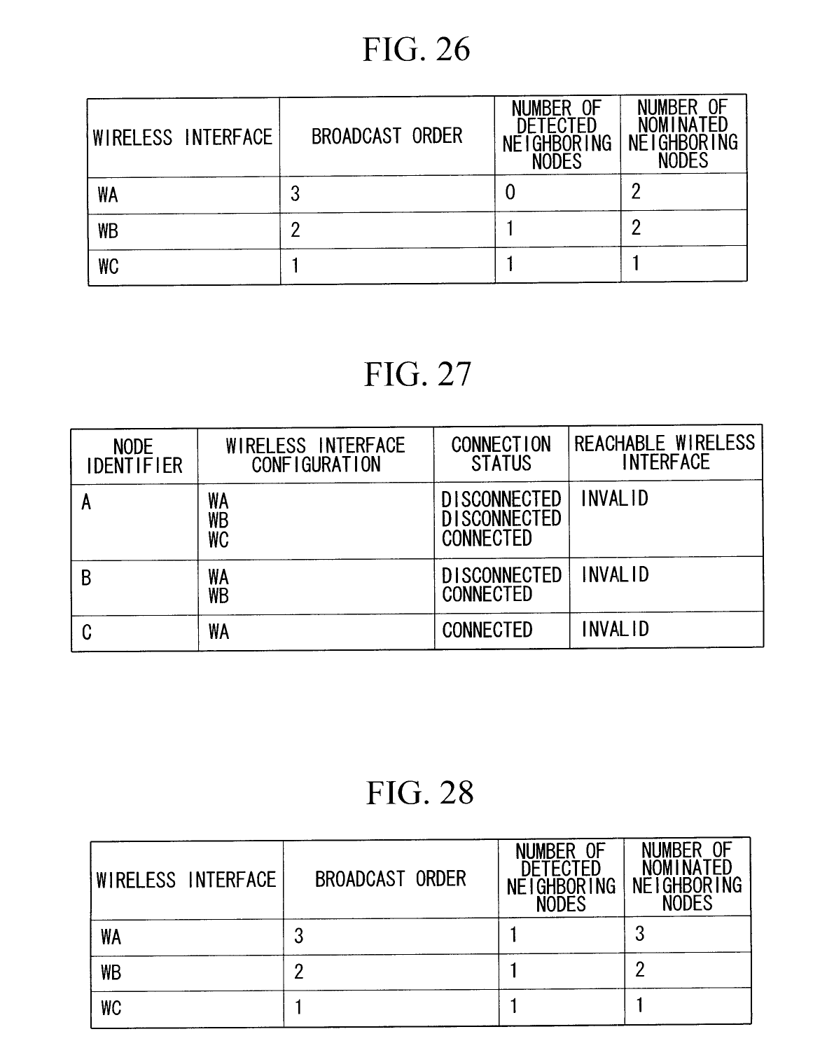

FIG. 26 shows the content of the private node wireless interface configuration table, which is stored in the storage 104 of the node 2001 at the present timing. With respect to the wireless interface WA, the broadcast order is “3”, the number of detected neighboring nodes is “0”, and the number of nominated neighboring nodes is “2”. With respect to the wireless interface WB, the broadcast order is “2”, the number of detected neighboring nodes is “1”, and the number of nominated neighboring nodes is “2”. With respect to the wireless interface WC, the broadcast order is “1”, the number of detected neighboring nodes is “1”, and the number of nominated neighboring nodes is “1”.

Next, the controller 103 of the node 2001 determines in step S15 that broadcasting is not performed using the wireless interface WA; hence, the flow returns to step S11. The transmitter 101 of the node 2001 broadcasts beacon messages via the wireless interface WA, which is selected based on the broadcast order of the private node wireless interface configuration table. Since the foregoing processing is still running, the sequence number included in the beacon message is “1”.

The receiver 102 of the node 2002 receives the beacon message broadcast by the transmitter 101 of the node 2001 in step S21. Since the combination of the node identifier Z and the sequence number “1” is already registered with the beacon management table stored in the storage 104 of the node 2002, the controller 103 determines in step S22 that the response message has already been sent back to the node 2001. In step S23, the receiver 102 of the node 2002 discards the received beacon message.

The receiver 102 of the node 2003 also receives the beacon message broadcast by the transmitter 101 of the node 2001 substantially at the same timing the receiver 102 of the node 2002 receives the beacon message in step S21. Since the combination of the node identifier Z and the sequence number “1” is already registered with the beacon management table of the storage 104 of the node 2003, the controller 103 determines in step S22 that the response message has already been sent back to the node 2001. In step S23, the receiver 102 of the node 2003 discards the received beacon message.

The receiver 102 of the node 2004 also receives the beacon message broadcast by the transmitter 101 of the node 2001 substantially at the same timing the receiver 102 of the nodes 2002 and 2003 receive the beacon messages in step S21. Since the combination of the node identifier Z and the sequence number “1” is not registered with the beacon management table stored in the storage 104 of the node 2004, the controller 103 determines in step S22 that no response message is sent back to the node 2001. In step S24, the transmitter 101 of the node 2004 performs unicast transmission so as to send the response message describing the node identifier C and the wireless interface WA to the node 2001; then, the node identifier Z and the sequence number “1” are registered with the beacon management table of the storage 104 of the node 2004.

The receiver 102 of the node 2001 receives the response message sent by the transmitter 101 of the node 2004 during the prescribed wait time in step S12; hence, the flow proceeds to step S13. In the region of the node identifier C of the neighboring node wireless interface configuration table stored in the storage 104 of the node 2001, the wireless interface configuration lists WA, the connection status is “connected” for WA, and the reachable wireless interface is “invalid”. In addition, “1” is added to the number of detected neighboring nodes (presently set to “0”) and the number of nominated neighboring nodes (presently set to “2”); thus, the number of detected neighboring nodes is updated to “1”, and the number of nominated neighboring nodes is updated to “3” with respect to the wireless interface WA in the private node wireless interface configuration table.

FIG. 27 shows the content of the neighboring node wireless interface configuration table, which is stored in the storage 104 of the node 2001 at the present timing. In the region of the node identifier A, the wireless interface configuration lists WA, WB, and WC, the connection status is “disconnected” for WA and WB and “connected” for WC, and the reachable wireless interface is “invalid”. In the region of the node identifier B, the wireless interface configuration lists WA and WB, the connection status is “disconnected” for WA and “connected” for WB, the reachable wireless interface is “invalid”. In the region of the node identifier C, the wireless interface configuration lists WA, the connection status is “connected” for WA, and the reachable wireless interface is “invalid”.

FIG. 28 shows the content of the private node wireless interface configuration table, which is stored in the storage 104 of the node 2001 at the present timing. With respect to the wireless interface WA, the broadcast order is “3”, the number of detected neighboring nodes is “1”, and the number of nominated neighboring nodes is “3”. With respect to the wireless interface WB, the broadcast order is “2”, the number of detected neighboring nodes “1”, and the number of nominated neighboring nodes is “2”. With respect to the wireless interface WC, the broadcast order is “1”, the number of detected neighboring nodes “1”, and the number of nominated neighboring nodes is “1”.

In step S15, the controller 103 of the node 2001 determines that broadcasting is completely performed using all the wireless interfaces; thus, the wireless interface configuration acknowledgement process is ended. At this time, the storage 104 of the node 2001 stores the neighboring node wireless interface configuration table whose content is shown in FIG. 27. In addition, it also stores the private node wireless interface configuration table whose content is shown in FIG. 28.

In connection with the second operation, the broadcast order determination process will be described with reference to FIG. 10. In step S100, the controller 103 of the node 2001 sorts the regions of the private node wireless interface configuration table in the order of larger numbers of detected neighboring nodes, thus provisionally assigning numbers representing the broadcast order to the sorted regions. According to the private node wireless interface configuration table shown in FIG. 28, the same number of detected neighboring nodes, i.e. “1”, is listed with respect to all the wireless interfaces WA, WB, and WC; hence, sorting is performed in the order of larger numbers of nominated neighboring nodes. Sorting results in arranging the wireless interfaces in the order of WA, WB, and WC; hence, the broadcast order “1” is assigned to the wireless interface WA, the broadcast order “2” is assigned to the wireless interface WB, and the broadcast order “3” is assigned to the wireless interface WC.

In step S200, the controller 103 of the node 2001 determines that examination is not completed with respect to all the wireless interfaces. In step S210, it selects the wireless interface WA whose broadcast order is “1” to be examined. In step S220, the controller 103 of the node 2001 determines that “valid” is described in the reachable wireless interface in the neighboring node wireless interface configuration table stored in the storage 104 of the node 2001. In step S230, it determines that the number of detected neighboring nodes is “1” or more with respect to the wireless interface WA (selected in step S210); hence, the flow proceeds to step S240.

In step S240, the controller 103 of the node 2001 determines that examination is not completed with respect to all the regions of the neighboring node wireless interface configuration table stored in the storage 104 of the node 2001. In step S241, it selects the region of the node identifier A, which is not examined, with reference to the neighboring node wireless interface configuration table. In step S242, the controller 103 of the node 2001 determines that the region of the node identifier A (selected in step S241) does not satisfy all the conditions dictating that the wireless interface configuration lists WA, the connection status is “connected” for WA, and the reachable wireless interface is “invalid”; hence, the flow returns to step S240.

In step S240, the controller 103 of the node 2001 determines that examination has not been completed with respect to the regions of the node identifiers B and C in the neighboring node wireless interface configuration table. In step S241, it selects the region of the node identifier B, which is not selected, with reference to the neighboring node wireless interface configuration table. In step S242, the controller 103 of the node 2001 determines that the regions of the node identifier B (selected in step S241) does not satisfy all the prescribed conditions dictating that the wireless interface configuration lists WA (selected in step S210), the connection status is “connected” for WA, the reachable wireless interface is “invalid”; hence, the flow returns to step S240.

In step S240, the controller 103 of the node 2001 determines that examination is not completed with respect to the region of the node identifier C in the neighboring node wireless interface configuration table. In step S241, it selects the region of the node identifier C, which is not examined, with reference to the neighboring node wireless interface configuration table. In step S242, the controller 103 of the node 2001 determines that the region of the node identifier C satisfies all the prescribed conditions dictating that the wireless interface configuration lists WA, the connection status is “disconnected” for WA, and the reachable wireless interface is “invalid”; hence, the flow proceeds to step S243. In step S243, the controller 103 of the node 2001 designates the wireless interface WA as the reachable wireless interface in the region of the node identifier C of the neighboring node wireless interface configuration table.

In step S200, the controller 103 of the node 2001 determines that examination has not been completed with respect to the wireless interfaces WB and WC. In step S210, it selects the wireless interface WB whose broadcast order is “2” to be examined. In step S220, the controller 103 of the node 2001 determines that the regions of the node identifiers A and B indicate “invalid” in the reachable wireless interface of the neighboring node wireless interface configuration table; hence, the flow proceeds to step S230. In step S230, it determines that the number of detected neighboring nodes is “1” or more with respect to the wireless interface WB (selected in step S210) with reference to the private node wireless interface configuration table; hence, the flow proceeds to step S240.

In step S240, the controller 103 of the node 2001 determines that examination is not completed with respect to all the regions of the neighboring node wireless interface configuration table. In step S241, it selects the region of the node identifier A, which is not examined, in the neighboring node wireless interface configuration table. In step S242, the controller 103 of the node 2001 determines that the regions of the node identifier A (selected in step S241) does not satisfy all the prescribed conditions dictating that the wireless interface configuration lists WB, the connection status is “connected” for WB, and the reachable wireless interface is “invalid”; hence, the flow returns to step S240.

In step S240, the controller 103 of the node 2001 determines that examination has not been completed with respect to the regions of the node identifiers B and C in the neighboring node wireless interface configuration table. In step S241, it selects the region of the node identifier B, which is not examined, in the neighboring node wireless interface configuration table. In step S242, the controller 103 of the node 2001 determines that the region of the node identifier B (selected in step S241) satisfies all the prescribed conditions dictating that the wireless interface configuration lists WB (selected in step S210), the connection status is “connected” for WB, and the reachable wireless interface is “invalid”; hence, the flow proceeds to step S243. In step S243, the controller 103 of the node 2001 designates the wireless interface WB as the reachable wireless interface in the region of the node identifier B of the neighboring node wireless interface configuration table; hence, the flow returns to step S240.

In step S240, the controller 103 of the node 2001 determines that examination has not been completed with respect to the region of the node identifier C in the neighboring node wireless interface configuration table. In step S241, it selects the region of the node identifier C, which is not examined, with reference to the neighboring node wireless interface configuration table. In step S242, the controller 103 of the node 2001 determines that the region of the node identifier (does not satisfy all the prescribed conditions dictating that the wireless interface configuration lists WB (selected in step S210), the connection status is “connected” for WB, and the reachable wireless interface is “invalid”; hence, the flow returns to step S240.

In step S240, the controller 103 of the node 2001 determines that examination is completed with respect to all the regions of the neighboring node wireless interface configuration table; hence, the flow proceeds to step S250. In step S250, it determines that the wireless interface WB is designated as the reachable wireless interface in the neighboring node wireless interface configuration table; hence, the flow returns to step S200. In step S200, the controller 103 of the node 2001 determines that examination has not been completed with respect to the wireless interface WC. In step S210, it selects the wireless interface WC whose broadcast order is “3” to be examined. In step S220, the controller 103 of the node 2001 determines that the reachable wireless interface is “invalid” with reference to the neighboring node wireless interface configuration table; hence, the flow proceeds to step S230. In step S230, it determines that the number of detected neighboring nodes is “1” or more with respect to the wireless interface WC with reference to the private node wireless interface configuration table; hence, the flow proceeds to step S240.

In step S240, the controller 103 of the node 2001 determines that examination is not completed with respect to all the regions of the neighboring node wireless interface configuration table. In step S241, it selects the region of the node identifier A, which is not examined, in the neighboring node wireless interface configuration table. In step S242, the controller 103 of the node 2001 determines that the region of the node identifier A satisfies all the prescribed conditions dictating that the wireless interface configuration lists WC (selected in step S210), the connection status is “connected” for WC, and the reachable wireless interface is “invalid”; hence, the flow proceeds to step S243. In step S243, the controller 103 of the node 2001 designates the wireless interface WC as the reachable wireless interface in the neighboring node wireless interface configuration table; hence, the flow returns to step S240.

In step S240, the controller 103 of the node 2001 determines that examination has not been completed with respect to the regions of the node identifiers B and C in the neighboring node wireless interface configuration table. In step S,241, it selects the region of the node identifier B, which is not examined, with reference to the neighboring node wireless interface configuration table. In step S242, the region of the node identifier B (selected in step S241) does not satisfy all the prescribed conditions dictating that the wireless interface configuration lists WC (selected in step S210), the connection status is “connected” for WC, and the reachable wireless interface is “invalid”; hence, the flow returns to step S240.

In step S240, the controller 103 of the node 2001 determines that examination has not been completed with respect to the region of the node identifier C in the neighboring node wireless interface configuration table. In step S241, it selects the region of the node identifier C, which is not selected, with reference to the neighboring node wireless interface configuration table. In step S242, the controller 103 of the node 2001 determines that the region of the node identifier C (selected in step S241) does satisfy all the prescribed conditions dictating that the wireless interface configuration lists WC (selected in step S210), the connection status is “connected” for WC, and the reachable wireless interface is “invalid”; hence, the flow returns to step S240.

In step S240, the controller 103 of the node 2001 determines that examination is completed with respect to all the regions of the neighboring node wireless interface configuration table; hence, the flow proceeds to step S250. In step S250, it determines that the wireless interface WC is designated as the reachable wireless interface in the neighboring node wireless interface configuration table; hence, the flow returns to step S200. In step S200, the controller 103 of the node 2001 determines that examination is completed with respect to all the wireless interfaces WA, WB, and WC; hence, the broadcast order determination process is ended.

FIG. 29 shows the content of the neighboring node wireless interface configuration table, which is stored in the storage 104 of the node 2001 at the present timing. In the region of the node identifier A, the wireless interface configuration lists WA, WB, and WC, the connection status is “disconnected” for WA and WB and “connected” for WC, and WC is designated as the reachable wireless interface. In the region of the node identifier B, the wireless interface configuration lists WA and WB, the connection status is “disconnected” for WA and “connected” for WB, and WB is designated as the reachable wireless interface. In the region of the node identifier C, the wireless interface configuration lists WA, the connection status is “connected” for WA, and WA is designated as the reachable wireless interface.

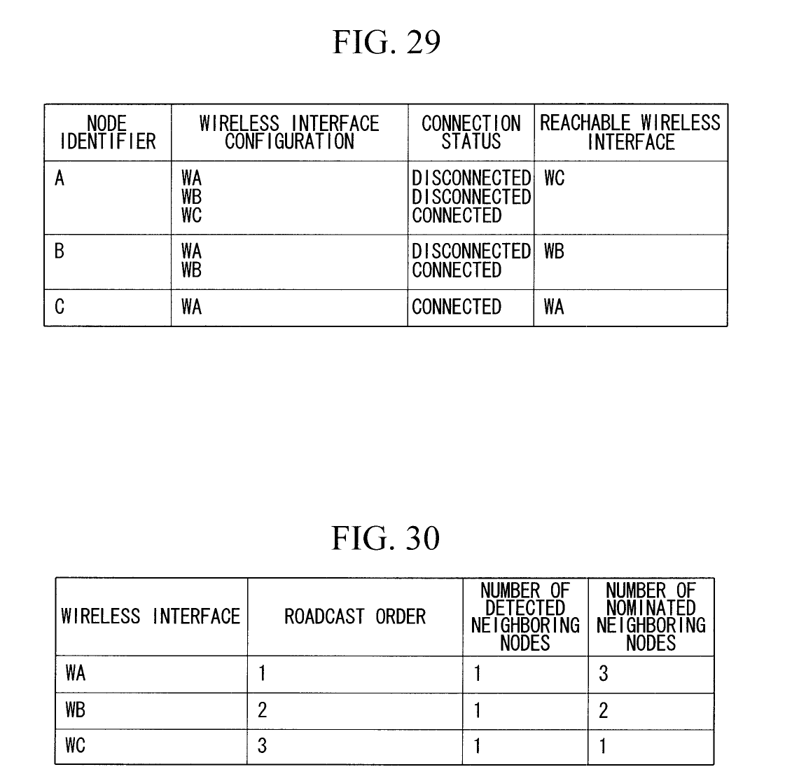

FIG. 30 shows the content of the private node wireless interface configuration table, which is stored in the storage 104 of the node 2001 at the present timing. With respect to the wireless interface WA, the broadcast order is “1”, the number of detected neighboring nodes is “1”, and the number of nominated neighboring nodes is “3”. With respect to the wireless interface WB, the broadcast order is “2”, the number of detected neighboring nodes is “1”, and the number of nominated neighboring nodes is “2”. With respect to the wireless interface WC, the broadcast order is “3”, the number of detected neighboring nodes is “1”, and the number of nominated neighboring nodes is “1”.

Thus, it is possible to appropriately produce the content of the neighboring node wireless interface configuration table and the content of the private node wireless interface configuration table by way of the aforementioned processes. In the usage 1, broadcasting is performed using the wireless interfaces WA, WB, and WC, all of which is not “invalid” in the broadcast order. In the usage 2 requesting that the number of reachable nodes is “2”, for example, broadcasting is performed using the wireless interfaces WA and WB. In the second operation, even though broadcasting reaching all neighboring nodes can be achieved using the wireless interface WA, the node 2001 performs broadcasting using all the wireless interfaces in the usage 1. In the second operation, even though broadcasting reaching two neighboring nodes can be achieved using the wireless interface WA, the node 2001 performs broadcasting using the wireless interfaces WA and WB in the usage 2.

The aforementioned matters may occur due to the initial status of the broadcast order. However, in the next cycle of the broadcast order determination process and the wireless interface configuration acknowledgement processes, which are executed periodically, these processes are performed in the order of larger numbers of nominated neighboring nodes, i.e. in the order of the wireless interfaces WA, WB, and WC. In the private node wireless interface configuration table, the broadcast order is “1”, and the number of detected neighboring nodes is “3” with respect to the wireless interface WA; hence, the next broadcasting is performed using only the wireless interface WA in both a usage 1 and usage 2. As a result, in the usage 1, broadcasting can be performed at an efficient usage of frequency minimizing duplication of data while ensuring packets reach all neighboring nodes. Similarly, in the usage 2, broadcasting can be performed at an efficient usage of frequency minimizing duplication of data while ensuring packets reach two neighboring nodes. The periodical execution of the aforementioned processes can be performed just before the execution of broadcasting. Alternatively, it can be performed in response to the timing for sending beacon messages (which are periodically transmitted with time intervals of several seconds). In IEEE 802.11, beacon messages are transmitted with 3-second time intervals; hence, the periodical execution of the aforementioned processes can be performed at this timing.

In the usage 3, broadcasting is performed using the wireless interfaces WA, WB, and WC, in which the number of nominated neighboring nodes is “1” or more. Thus, it is possible to perform effective broadcasting reaching all neighboring nodes while avoiding unnecessary broadcasting by use of the wireless interfaces WA, WB, and WC.

Lastly, the present invention is not necessarily limited to the aforementioned examples and operations, which can be further modified in a variety of ways within the scope of the invention as defined in the appended claims.

What is claimed is:

1. A wireless communication device comprising:
a transmitter suiting a plurality of wireless communication methods;
a receiver suiting the plurality of wireless communication methods; and
a controller for determining a broadcast order with regard to the plurality of wireless communication methods,
wherein the transmitter broadcasts a beacon message to a counterpart wireless communication device, which in turn sends back a response message describing a node identifier and at least one usable wireless communication method to the receiver,
wherein the controller determines the broadcast order based on the response message, and
wherein the transmitter performs broadcasting or multicasting based on one of the wireless communication methods, which is determined based on the broadcast order.

2. A wireless communication device comprising:
a transmitter suiting at least one wireless communication method;
a receiver suiting the at least one wireless communication method; and
a controller for determining a broadcast order with regard to the at least one wireless communication method,
wherein the receiver receives a beacon message from a counterpart wireless communication device, and
wherein the transmitter sends a response message sending a node identifier and the at least one wireless communication method to the counterpart wireless communication device.

3. A wireless communication device according to claim 1 further comprising a storage for storing the node identifier and the sequence number thereof, wherein the transmitter sends the beacon message sending the node identifier and the sequence number to the counterpart wireless communication device based on the plurality of wireless communication methods sequentially.

4. A wireless communication device according to claim 2 further comprising a storage for storing the node identifier and the sequence number thereof, wherein the controller determines whether or not the storage stores the node identifier and the sequence number included in the beacon message received by the receiver, and wherein when the controller determines that the storage does not store the node identifier and the sequence number included in the beacon message, the storage is controlled to store the node identifier and the sequence number included in the beacon message, so that the transmitter sends back the response message to the counterpart wireless communication device.

5. A wireless communication device according to claim 1, wherein the controller selects at least one of the wireless communication methods via which the receiver receives the response message, and wherein the transmitter performs broadcasting or multicasting based on the selected wireless communication method.

6. A wireless communication device according to claim 1, wherein the controller selects at least one of the wireless communication methods reaching a prescribed number of neighboring nodes, so that the transmitter performs broadcasting or multicasting based on the selected wireless communication method.

7. A wireless communication device according to claim 1, wherein the receiver receives the response message from the counterpart wireless communication device, so that the transmitter performs broadcasting or multicasting based on the at least one usable wireless communication method.
